(19) United States
(12) Patent Application Publication
(10) Pub. No.: US 2026/0244661 A1
(43) Pub. Date: Aug. 20, 2026

(54) Generative Business Intelligence

(71) Applicant: TURSIO INC., BELLEVUE, WA (US)

(72) Inventors: ALEKH JINDAL, Sammamish, WA (US); SHI QIAO, Mercer Island, WA (US); Wangda ZHANG, Bellevue, WA (US)

(73) Assignee: TURSIO INC., BELLEVUE, WA (US)

(21) Appl. No.: 19/642,494

(22) Filed: Apr. 8, 2026

Related U.S. Application Data
(63) Continuation-in-part of application No. 18/415,451, filed on Jan. 17, 2024, now Pat. No. 12,608,670.
(60) Provisional application No. 63/439,337, filed on Jan. 17, 2023.
(60) Provisional application No. 63/531,882, filed on Aug. 10, 2023.
(60) Provisional application No. 63/974,168, filed on Feb. 2, 2026.
(60) Provisional application No. 63/981,077, filed on Mar. 20, 2026.

(51) Int. Cl. G06F 16/3329; G06F 16/2452; G06F 40/284; G06F 40/30

(52) U.S. Cl. CPC G06F 16/33295; G06F 16/24522; G06F 40/284; G06F 40/30

(57) ABSTRACT

Implementations described herein relate to systems and methods for generating responses to natural language input. The system deconstructs a natural language query into a plurality of fragments, which are then analyzed to identify relevant query operators. This interpretation is mediated by domain knowledge encapsulated in synthetic questions generated through an automated offline training process. A structured query tree is constructed using the identified operators and executed on a data source to retrieve an output result. To ensure structural integrity, the system utilizes deterministic grounding via hash-based predictors and performs a structural exploration of join-graph reachability to synthesize a topologically ordered join tree. The resulting data is then used to generate a tailored response, which may include inferred visualization elements, detected anomalies, or natural language reports.

### CROSS-REFERENCE TO RELATED APPLICATIONS

This application is a continuation in part of U.S. patent application Ser. No. 18/415,451, filed 17 Jan. 2024, titled “GENERATIVE BUSINESS INTELLIGENCE,” which claims priority to U.S. Provisional Patent Application No. 63/439,337 filed 17 Jan. 2023, titled “AUTOMATIC GENERATION OF BUSINESS INTELLIGENCE APPLICATIONS AND DASHBOARDS” and claims priority to U.S. Provisional Patent Application No. 63/531,882 filed 10 Aug. 2023, titled “DATABASE DRIVEN GENERATIVE ARTIFICIAL INTELLIGENCE.” This application is also a continuation in part of Ser. No. 19/553,423, filed 1 Mar. 2026, titled “SCALABLE JOIN INFERENCE FOR KNOWLEDGE GRAPHS.” This application also claims priority to U.S. Provisional Patent Application No. 63/974,168, filed 2 Feb. 2026, titled “SYSTEMS AND METHODS FOR CONTEXT-AWARE SEARCHABLE DATABASE ABSTRACTIONS” and to U.S. Provisional Patent Application No. 63/981,077, filed 20 Mar. 2026, titled “Reverse Migration of Cloud Applications to On-premises.” All of the above identified applications are incorporated by reference herein in their entirety.

### TECHNICAL FIELD

Implementations relate generally to business intelligence, and specifically to artificial intelligence based business intelligence applications. Implementations further relate to guided table retrieval for structured data search, utilizing deterministic grounding and structural exploration of join-graph reachability.

### BACKGROUND

Business intelligence refers to the use of data for decision making. Early instances of business intelligence applications date back to 1865 when a banker received and acted on information about battles fought, to gain profits. The term business intelligence came into more formal existence in 1989 when it was described as “a set of concepts and methods to improve business decision making by using fact-based support systems.” Business intelligence gained more popularity in the late 90s and over time it is considered to include reporting, dashboarding, online analytical processing, data mining, alerting, benchmarking, predictive analytics, prescriptive analytics, business analytics, etc.

Existing approaches often treat query generation as a ‘one-shot’ black-box translation, leading to ‘hallucinations’ of columns or semantically incorrect SQL due to a lack of internal data context.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes receiving the question as a natural language string. The receiving also includes determining one or more fragments based on the natural language string; identifying one or more query operators based on the one or more fragments; constructing a structured query tree based on the one or more query operators; executing at least a portion of the structured query tree on a data source; receiving, from the data source, an output result based on the execution; generating the response based on the output result; and providing the response to the user. Other implementations of this aspect include corresponding computer systems, apparatus, and computer programs recorded on one or more computer storage devices, each configured to perform the actions of the methods.

Implementations may include one or more of the following features. The computer-implemented method where determining the one or more fragments may include at least applying a large language model to the natural language string. Determining the one or more fragments further may include providing synthetic questions that are similar to the natural language string to the large language model. Identifying the one or more query operators may include performing feature extraction on the one or more fragments. Constructing the structured query tree based on the one or more query operators may include constructing the structured query tree based on a target data source. Executing at least the portion of the structured query tree may include performing an optimized execution of the structured query tree. The data source is a large data model generated from a primary data source. The receiving the question may include receiving the question at an artificial intelligence AI agent, where the AI agent is an instantiation of a plurality of machine learning models that are particular to a domain associated with a computing device that originated the question. Receiving the questions as the natural language string may include receiving an input via a voice to text converter. Generating the response may include inferring one or more visualization elements based on the output result. A type of visualization element is based on a cardinality of data points in the output result. The computer-implemented method may include detecting one or more anomalies in the output result. The computer-implemented method may include generating a plurality of synthetic questions for respective domains based on metadata from ontology of the domains. Generating the plurality of synthetic questions for a particular domain may include combining a plurality of fragments, where each fragment is generated based on components included in a data source associated with the particular domain. Implementations of the described techniques may include hardware, a method or process, or computer software on a computer-accessible medium.

The non-transitory computer-readable medium also includes receiving a question as a natural language string; determining one or more fragments based on the natural language string; identifying one or more query operators based on the one or more fragments; constructing a structured query tree based on the one or more query operators; executing at least a portion of the structured query tree on a data source; receiving, from the data source, an output result based on the execution; generating the response based on the output result; and providing the response to a user. Other implementations of this aspect include corresponding computer systems, apparatus, and computer programs recorded on one or more computer storage devices, each configured to perform the actions of the methods.

Implementations may include one or more of the following features. The non-transitory computer-readable medium where determining the one or more fragments may include at least applying a large language model to the natural language string. Determining the one or more fragments further may include providing synthetic questions that are similar to the natural language string to the large language model. Implementations of the described techniques may include hardware, a method or process, or computer software on a computer-accessible medium.

The system also includes a memory with instructions stored thereon; and a processing device, coupled to the memory, the processing device configured to access the memory and execute the instructions, where the instructions cause the processing device to perform operations including: receiving a question as a natural language string; determining one or more fragments based on the natural language string; identifying one or more query operators based on the one or more fragments; constructing a structured query tree based on the one or more query operators; executing at least a portion of the structured query tree on a data source; receiving, from the data source, an output result based on the execution; generating the response based on the output result; and providing the response to a user. Other implementations of this aspect include corresponding computer systems, apparatus, and computer programs recorded on one or more computer storage devices, each configured to perform the actions of the methods.

Implementations may include one or more of the following features. The system where the receiving the question may include receiving the question at an artificial intelligence AI agent, where the AI agent is an instantiation of a plurality of machine learning models that are particular to a domain associated with a computing device that originated the question. Identifying the one or more query operators may include performing feature extraction on the one or more fragments. Implementations of the described techniques may include hardware, a method or process, or computer software on a computer-accessible medium.

### BRIEF DESCRIPTION OF THE DRAWINGS

FIG. 1A depicts a system environment utilized for business intelligence applications, in accordance with some implementations.

FIG. 1B depicts an example system architecture to implement artificial intelligence powered business intelligence applications, in accordance with some implementations.

FIG. 1C depicts an example architecture for smart applications (smartapps), in accordance with some implementations.

FIG. 2A illustrates an example framework for performing domain specific specialization of an artificial intelligence agent, in accordance with some implementations.

FIG. 2B illustrates a hierarchical flow diagram for an automated query context generation process utilizing canonical query trees and relational operators, in accordance with some implementations.

FIG. 3A depicts an example workflow to implement natural language query processing, in accordance with some implementations.

FIG. 3B depicts an example workflow to perform guided table retrieval, in accordance with some implementations.

FIG. 4 depicts an example workflow to generate a response to business intelligence questions, in accordance with some implementations.

FIG. 5A depicts example elements of stored business data at a data source, in accordance with some implementations.

FIG. 5B depicts an example business intelligence question and corresponding fragments, operators, and a structured query tree, in accordance with some implementations.

FIG. 5C depicts another example business intelligence question and corresponding fragments, operators, and a structured query tree, in accordance with some implementations.

FIG. 6A depicts an example method to automatically generate a response to a business intelligence question, in accordance with some implementations.

FIG. 6B depicts an example method to generate a response to a natural language input, in accordance with some implementations.

FIG. 7A describes an example method to generate synthetic questions associated with a database schema, in accordance with some implementations.

FIG. 7B describes another example method for orchestrated data model generation to produce a query context library, in accordance with some implementations.

FIG. 7C describes an example method to sample quantitative metrics from a database schema to populate query templates, in accordance with some implementations.

FIG. 7D describes an example method to perform categorical dimension selection in automated query generation, in accordance with some implementations.

FIG. 7E describes an example method to synthesize conditional aggregation filters for a relational database query context, in accordance with some implementations.

FIG. 7F describes an example method to perform guided table retrieval for a database scheme, in accordance with some implementations.

FIG. 7G depicts an example TPC-H join graph, in accordance with some implementations.

FIG. 8 depicts another example method to automatically generate a response to a business intelligence question, in accordance with some implementations.

FIG. 9A depicts an example of generative actions based on user conversation, in accordance with some implementations.

FIG. 9B depicts example code generation, in accordance with some implementations.

FIG. 10 depicts example dashboards, in accordance with some implementations.

FIG. 11 depicts an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some embodiments”, “an embodiment”, “an example embodiment”, etc., indicate that the embodiment described may include a particular feature, structure, or characteristic, but every embodiment may not necessarily include the particular feature, structure, or characteristic. Similarly, references in the specification to “some implementations”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same embodiment or implementation. Further, when a particular feature, structure, or characteristic is described in connection with an embodiment, such feature, structure, or characteristic may be implemented in connection with other embodiments whether or not explicitly described.

Business intelligence is the use of data for decision making. The traditional approach for business intelligence is to get the business requirements, prepare the data models, and finally create dashboards for the end users.

Implementing business intelligence (BI) processes comes with several notable challenges. Initially, there's a significant amount of preparatory work required, as data must be transformed before any dashboards can be developed. This task is further complicated by the need to move data, as most BI tools require extracting data to build data models. This process demands the expertise of domain specialists who can effectively translate business requirements into functional data models.

Moreover, maintaining these data transformations is a tedious and ongoing task. The time investment for typical BI projects is substantial, often extending into weeks or months before any actionable insights can be derived. Additionally, the process involves manual labor, which not only adds to the expense but also increases the risk of errors.

Techniques of this disclosure may be utilized to automatically process natural language strings and perform complex data source operations, e.g., execute query operators, etc.

The present disclosure relates to a computer-implemented method designed to efficiently and accurately generate responses to business intelligence questions and/or other prompts posed by users. This method is particularly focused on handling and processing questions received in natural language form. Upon receiving a question, the business intelligence system first interprets the query as a natural language string, breaking it down into manageable fragments. The interpretation is mediated by domain knowledge that is encapsulated in synthetic questions that are generated offline through a training process. These fragments are then analyzed to identify relevant query operators, which are integral to understanding the intent and requirements of the original question.

Following this, a structured query tree is constructed utilizing the identified query operators. This tree serves as a blueprint for querying a data source, allowing for a systematic and logical approach to data retrieval from the data source. The system then executes at least a portion of this structured query tree on the chosen data source, ensuring that accurate information is extracted based on the user's query.

Subsequently, the system receives an output result from the data source, which is directly based on the executed query tree. This output result includes the essential data or information pertinent to the user's original business intelligence question. The final step involves the system generating a response based on the output result. This response is tailored to accurately and comprehensively address the user's query, translating the complex data output into an understandable format.

Finally, this generated response is provided back to the user, completing the cycle of question and response. This method significantly enhances the efficiency and accuracy of responding to business intelligence questions, especially those posed in natural language, and is adaptable to various data sources and business environments. This approach offers a technical solution to the problem of processing natural language strings that are directed to a data source and provides accurate results when compared to one-shot techniques. Determining fragments based on previously generated synthetic questions and eventually, the query operators, provides a technical advantage in that any interpretation of the natural language string is guaranteed to resolve into objects, e.g., entities, attributes, measures, etc., that are guaranteed to be included in the data source.

Some previous approaches have described processing an entire question and generating query operators, e.g., SQL queries. This can lead to erroneous translation, and to the generation of invalid query trees. Furthermore, one-shot translations that result in execution errors necessitate iterative re-processing, leading to unnecessary consumption of processor cycles and increased latency in high-volume enterprise environments.

A fragment based approach, as described herein represents a bottoms up approach, whereby fragments are formed first and subsequently mapped to query operators and query trees. The approach described herein provides more accurate results and to queries that are always valid. This can lead to faster computational times, reduced resource use, and to more accurate end results and business intelligence results and/or insights.

Traditional natural language database interfaces suffer from several deep-seated technical deficiencies:

Semantic Inaccessibility: Relational databases are the “systems of record” for enterprises, yet their schemas are often abbreviated (e.g., “c_acctbal”) or lack explicit relationships, making them indecipherable to non-experts and general-purpose Large Language Models (LLMs).

The “Black Box” Hallucination Problem: Existing generative AI approaches often treat query generation as a “one-shot” black-box translation task. Without deep context of the internal data and structural constraints, these models are prone to “hallucinating” columns or generating syntactically valid but semantically incorrect SQL.

The Scalability and “Cold Start” Bottleneck: High-quality AI-database interaction requires extensive “query context” (sample question-SQL pairs) to ground the model. Manually creating this context is computationally expensive, time-consuming, and requires rare expertise in both SQL and specific enterprise schemas.

Dynamic Data Drift: Enterprise data and schemas evolve constantly, rendering static fine-tuned models or manually curated context libraries obsolete almost immediately.

Techniques described herein provide a technical solution that transforms query generation from a probabilistic “guess” into a deterministic, multi-step computer process.

Automated Semantic Knowledge Graph Inference: The system overcomes the “semantic gap” by automatically building a semantic knowledge graph. It uses specialized profiling algorithms to clean data (e.g., via Inter-Quartile Range filtering), classify metrics, and discover inclusion dependencies to map the underlying database structure.

Multi-Stage Systematic Query Planning: Rather than relying on black-box memorization, the system deconstructs natural language queries through a rigorous pipeline: Parsing into meaningful operators, Grounding operands into valid metadata, Generating a well-formed relational algebra tree, and Transforming the tree to enforce row-level security and resolve aggregate inconsistencies.

Automated Context Synthesis via Query Flows: To solve the “cold start” and maintenance problems, the system employs a novel automated approach to generate a query context library. By traversing a seven-level query flow, the system systematically synthesizes diverse question-data model pairs that provide 100% coverage of both schema elements and data points.

Statistical Level and Measure Sampling: The solution integrates specific sampling algorithms (e.g., Inverse-Frequency Level Diversification) to ensure the AI is grounded in under-utilized parts of the schema, thereby maximizing the robustness and reliability of the generated queries across the entire database.

This approach represents an improvement to the computer's ability to process natural language by grounding it in a structured relational framework. By using deterministic hash-based predictors and join graph traversal, the system reduces the search space and focuses LLM reasoning only on high-quality candidates, significantly improving computational efficiency and accuracy compared to generic prompt-based methods.

By grounding the query in a structured relational framework before LLM engagement, the system significantly reduces the volume of metadata required in the prompt context, thereby optimizing memory usage and reducing the token-based computational cost of the reasoning model.

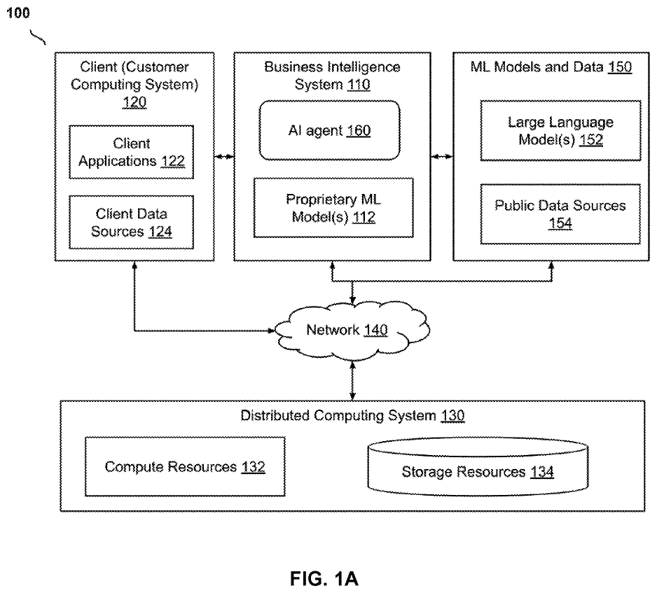

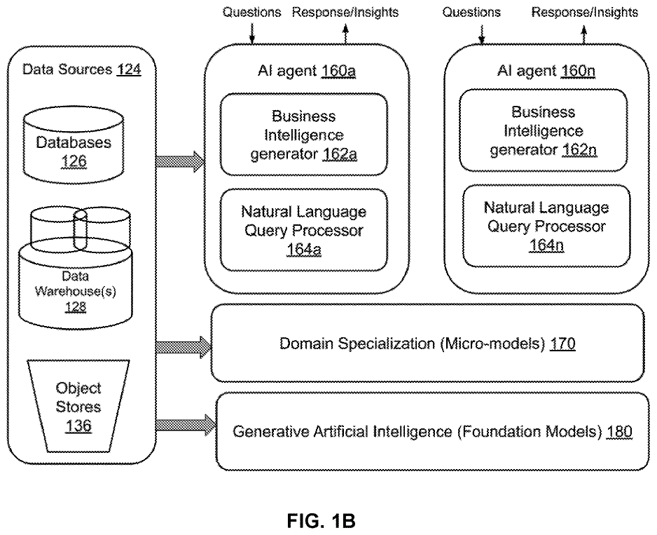

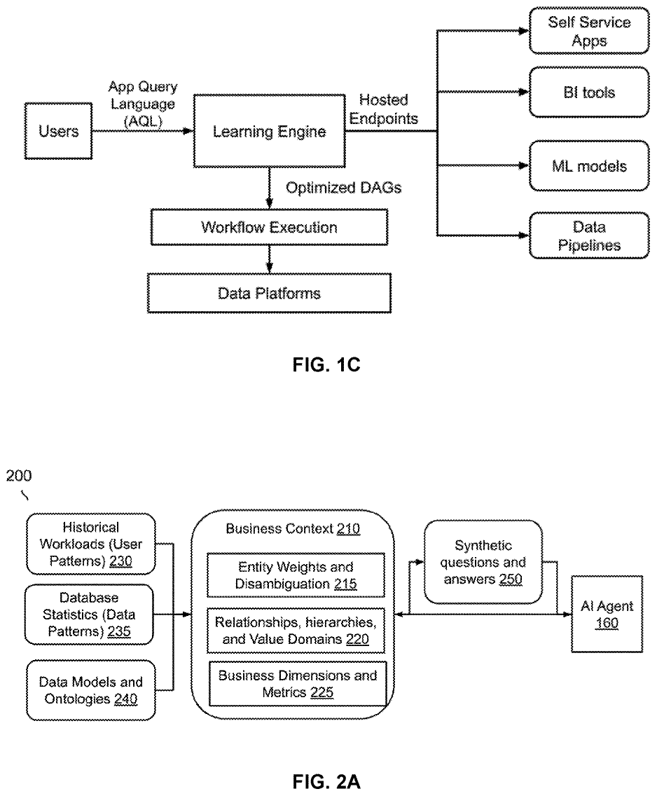

FIG. 1A depicts a system environment utilized for business intelligence applications, in accordance with some implementations.

As depicted in FIG. 1A, a business intelligence system 110 includes an AI agent 160 and proprietary machine learning (ML) models. The business intelligence system 110 is connected via network 140 to client computing system 120, to public ML models/Data 150, and to distributed computing system 130.

The client computing system 120 may include client applications 122 that may be installed on user devices, computer devices, etc., as well as client data sources 124.

The distributed computing system 130 may be utilized to perform various business intelligence tasks and may include both compute resources 132 and storage resources 134.

The ML models and Data 150 may include large language model(s) 152 and public data sources 154.

FIG. 1B depicts an example system architecture to implement artificial intelligence powered business intelligence applications, in accordance with some implementations.

Per techniques of this disclosure, domain-specific artificial intelligence (AI) agents are utilized to address business inquiries and/or questions. This is achieved by adapting foundational generative AI models, both for data and language, into specialized micro-models tailored to various business sectors such as retail, manufacturing, banking, consumer goods, etc. These micro-models are employed to create AI agents capable of directly extracting answers from diverse data sources. The approach offers several advantages, including keeping data at its source without the need for updates, automating manual data transformations within the domain-specific adaptations, integrating business context into the AI agent, allowing business users to query in their context, scaling with minimal effort to accommodate numerous questions and stakeholders, and eliminating the creation of superfluous dashboards, thus focusing on generating only essential reports.

The business intelligence system utilizes generative business intelligence, and includes key components, e.g., domain specialization, natural language query processor, and a business intelligence generator.

As depicted in FIG. 1B, data sources 124 can include databases 126, data warehouses 128, and object stores 136.

Each AI agent 160 may include a business intelligence generator 162 and a natural language query (question) processor 164. Each AI agent is customized for a particular domain and/or client and can receive natural language questions as inputs and provide responses/insights.

The business intelligence system additionally includes and/or can access domain specialization modules (micro-models) 170 and generative artificial intelligence models (foundational models) 180, which may be generalized models that are trained over large data sets and are not specific to any particular domain.

FIG. 1C depicts an example architecture for smart applications (smartapps), in accordance with some implementations.

The next generation of businesses require data and apps to come together, for better efficiencies and productivity, in realizing the true business potential. This goes way beyond business intelligence 2.0, and the new approach needs to be AI-driven in creating a data-app flywheel for providing a smooth uninterrupted app experience for the users, while taking care of complex mechanics behind the scenes. This may be termed AI-driven approach as business intelligence 3.0 and three new concepts may be introduced to characterize it:
1. Conversational. Business intelligence tools need to be conversational, where users can ask their business questions more naturally based on their context. Users focus on what they want and not how they are going to get it, thus eliminating the barriers for anyone looking for intelligence from a given corporate data.
2. Generative. Business intelligence tools need to generate all complex mechanics behind the scenes, the ‘how’ part. These include generating enriched conversations, backend workflows, data preparation, optimizations, recommendations, automations, visualizations, end points, and even the semantic meaning to connect data with business questions.
3. Managed: Business intelligence tools need to be fully managed SaaS, hosting a learning-based application environment for user interactions, backend workflows, and frontend visualizations. All this happens via an on-demand, auto scaled, and usage-based, instead of user-based, pay-as-you-go infrastructure.

Productivity. Business intelligence 3.0 will dramatically reduce the time to transform business data into intelligence. The generative approach will help create new dashboards in minutes compared to days, boosting productivity by factors of up to 200 (200×).

Performance. By removing the silos between app and data, business intelligence 3.0 generates the most efficient backend workflows that bring down dashboard load times from minutes to seconds, bringing in a speed up of 20×!

Cost. By focusing on declarative business needs, business intelligence 3.0 generates smart automations and end-to-end optimizations to bring down the overall. This coupled with usage-based pricing reduces the cost of both app platforms by a factor of 4(4×) and data platforms by a factor of 2(2×).

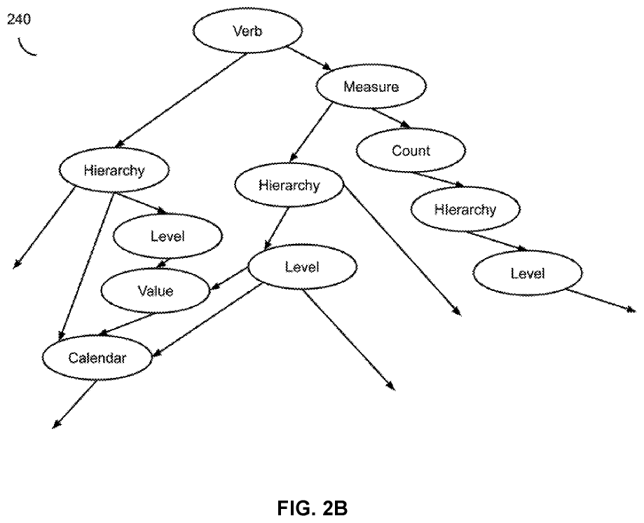

FIG. 2A illustrates an example framework for performing domain specific specialization of an artificial intelligence agent, in accordance with some implementations.

Business intelligence is commonly domain specific. Therefore, a generator approach may beneficially incorporate knowledge from a given domain. Additional details of the operations are described herein.

Domain specific data models and ontologies and obtained. These are the terminologies used to describe a business domain and the underlying data structures to get them from the data sources. The ontologies include mappings of terms (words) utilized in a particular domain to specific portions of one or more associated data sources.

The left-hand side, e.g., of the mapping, primarily consists of all the words, while the right-hand side potentially represents the mapping to the underlying data source, and specific elements in the data source. This mapping could take the form of a table or an expression applied to a table, such as calculating the sum, maximum, or average. It may refer to either a term within the data source or an expression that can be applied to the data source.

This entire system is, in essence, a comprehensive dictionary of all things. It could manifest in the form of a dictionary list, and might also include tables, which are, in this context, sub-mappings. Data source information may be ingested through this process.

When a user provides an input, e.g., “Show me sales in Agra,” it raises the question of how the system can ascertain whether “Agra” actually refers to a location. The business intelligence system performs this determination through semantics. By capturing in an ontology, a dimension called ‘location’ and familiarity with valid values for the dimension, the ontological knowledge enables the business intelligence system to interpret a question correctly, e.g., by demonstrating an understanding that when referring to “Agra”, the user is in fact referring to a location.

The process involves analyzing the terms that are utilized by users in the domain, and the values present in the data source (database). This analysis might involve extracting values and interpreting them. To achieve this, comprehensive dictionaries and vocabularies are deployed in addition to smaller, more nuanced inference models. These models enable the inference of the most semantically similar meanings to the terms and fragments you use. For instance, even if the term is not explicitly ‘Agra’, but something similar, the inference models can enable determination of the nearest term that could potentially mean the same thing.

Extract relevant business dimensions, e.g., customers, locations, etc., and their associated metrics, e.g., revenue, churn, etc. These dimensions and metrics are how stakeholders ask questions in their business.

Dimensions and metrics could map directly from the database or could be derived via further processing. Data models capture those additional processing required to do the derivation and business questions must be answered against those domain specific data models to get the semantics correct. The system may be utilized to create additional data models for processing the business questions.

Database statistics, summaries and samples, etc., are then gathered to get an understanding of the data patterns underlying the business semantics (data models and ontologies). Database statistics are used to infer the relationships, hierarchies, and valid values domains, so that the business questions could be interpreted correctly with respect to the underlying data. Historical query workloads are subsequently utilized to learn the user patterns and assign weights to various entities for disambiguation and ranking. These weights help to make the best decisions when interpreting questions with several possible meanings.

All of the above information together constitutes the business context, and it is specific to an instance within the business domain.

The process of translating the inputs (domain models/ontologies, database statistics, and historical workloads) to business context is automated by training on many previously seen examples. From the business context, a set of synthetic questions and answers are generated that are relevant to the specific business instance. These are representative of both the semantics and the data for that business domain.

The business context and the synthetic question answers are provided to the AI agent for answering business questions.

### Generating Synthetic Questions

Given the metadata from the ontology and database, the components of a question are identified, such as dimensions, measures, grouping, aggregation, ordering, advanced analysis, etc. For each component, valid values are retrieved from the domain to create valid combinations of values for different components. In some implementations, a valid combination is one which has entries in the underlying database. Natural language question fragments are generated for each of the components and their values. The question fragments are combined into a full sentence question, and the grammar of the top-k questions may be improved to make them sound more natural. For the remaining questions, a request may be transmitted to an LLM to adapt them such that they sound more natural as follows:
a. Provide the manually curated top-k questions and their corresponding components as context.
b. Pose a query to an LLM to make the question for a new set of components more natural.

This approach builds the synthetic questions context bottom-up, i.e., they are guaranteed to be correct.

In some implementations, a set of synthetic questions is generated offline, and a subset of the set of synthetic questions may be selected during real-time processing of natural language input received, e.g., from a user.

FIG. 2B illustrates a hierarchical flow diagram for an automated query context generation process utilizing canonical query trees and relational operators, in accordance with some implementations.

Reference is now made to FIG. 2B, which illustrates an exemplary implementation of a seven-level query flow utilized by the system to systematically generate diverse query contexts. The process involves traversing a plurality of nodes to construct a data-model/question pair that uniquely covers both the schema and specific data points of an underlying relational database.

As shown in FIG. 2B, the generation process initiates at the Verb node, which specifies an action word (e.g., Show, List, Compare, or Trend) indicating the intended type of query. From the Verb node, the flow branches into quantitative and categorical paths. The Measure node identifies quantitative metrics (e.g., total sales or average revenue) to be aggregated, which may further branch into a Count node for retrieving a specific number of top or bottom items.

The flow further proceeds to a Hierarchy node, representing the primary table or entity being queried (e.g., sales or customers). Connected to the Hierarchy node are one or more Level nodes, which represent categorical dimensions for grouping or filtering, such as region or product category. To increase precision, a Value node is provided to instantiate these levels with specific data values extracted from the database (e.g., country=‘Germany’, product=‘Laptop’).

In some implementations, the flow terminates at or incorporates a Calendar/Date Filter node. This node applies temporal constraints, such as specific date ranges or date comparisons (e.g., “from Jan 2024 to June 2025”), to the canonical query tree.

The construction of these elements follows a bottom-up approach using relational operators, including project, select, join, and aggregate. The resulting structured query structure is then translated into an equivalent natural-language question, as illustrated in the variations shown in FIG. 1A. This systematic navigation through the nodes of FIG. 2B ensures that the generated query context library is both diverse and representative of common patterns of data retrieval and analysis.

To systematically generate diverse query contexts, a set of query flows that represent common patterns of data retrieval and analysis questions is defined. Each query flow maps to a particular combination of operations (e.g., aggregation, filtering, sorting, etc.) and the types of schema elements (e.g., dimensions, measures, etc.) involved. This mapping is provided to the LLMs to guide the query generation.

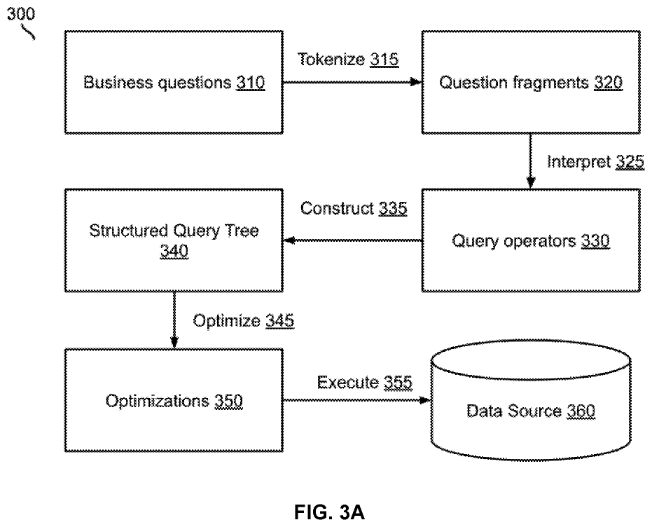

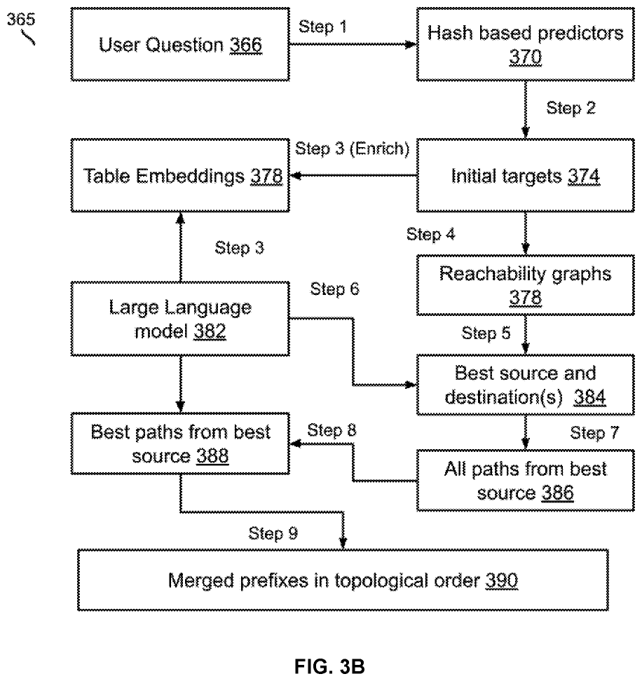

FIG. 3A depicts an example workflow to implement natural language query processing, in accordance with some implementations.

FIG. 3A depicts an example workflow 300 that describes how specialized generative models may be adapted to a specific domain. Received business questions (310) are tokenized (315) to form question fragments (320). The question fragments 320 are interpreted (325) to generate query operators (330). From the query operators (330), a structured query tree (340) is constructed (335). The structured query tree (340) is optimized (345) via one or more optimizations (350) and then executed (355) on one or more data sources (360).

Natural language questions are domain questions requiring business logic, and not database questions involving files and tables. Therefore, the natural language questions are processed using the domain specific information before it could be executed on the database. The workflow below shows the various steps in an example natural language query processor. The various steps are described herein.
The first step is to break the user's questions into fragments. This is done using the business context and the typical components to a question seen in that business domain. A combination of generative AI e.g., large language models (LLMS) and classical machine learning (ML) models may be utilized to fragment a question into smaller workable pieces (fragments).
Select a subset of top-k synthetic questions that are semantically most similar to the user question;
Provide these questions as inputs for the LLM to generate the query fragments
In case of ambiguity, use a probabilistic ML model to split a large fragment further or combine smaller fragments together
For questions that follow previously observed (seen) patterns, a classifier ML model is utilized to map the question into likely fragments, e.g., typically seen subject and predicate clauses, or typically asked dimensions and measures.

Perform a cache storage of fragment patterns for future reuse.

Ensure similarity and diversity.

A next operation is to interpret each fragment into valid and meaningful query operators. This uses the synthetic questions/answers as context to understand how similar fragments are interpreted in that domain. In addition, database statistics related constraints may be imposed to ensure a valid interpretation.

The models used are a combination of classification and regression models.

The input is the question and the business context.

Features are extracted from the question fragment, based on what terms on their lemmatizations are present in the fragment, e.g., does it talk about products, or customers, or revenue.

The interpretation may be ranked based on database statistics, e.g., is revenue most frequently mapped to quarterly revenue or annual revenue, does Apple refer to a product or a company in my domain, and so on.

Identifying the query processing needed to answer the question, e.g., revenue trends, or month with maximum revenue, or total sales.

The operators are then composed into a structured query tree for the backend database. The query is formulated against relevant data models (business specific or generated by the system). Depending on the database backend and its supported dialect, multiple query trees may be utilized to get the intended answer.

Identifying what underlying data models should be used to process a query.

The query tree is optimized for performance, leveraging techniques for caching and pre-computation. The structured query may then be executed on the data source. Commonly, disambiguation may need to be performed when an exact match is not identified. An example disambiguation algorithm is described herein.
1. A fragment, F, may be disambiguated into entity, dimensions, measure, or functions over them. A function could be relational, e.g., filter, aggregate, join, or a scalar expression, e.g., absolute, transpose, etc.

### 2. To Disambiguate Entities:

a. Hash-based classifiers are created over the names and value domains of all existing entities, obtained from both the ontology and the database.
b. If F matches the name of any entity E, then E is returned.
c. If F is contained in any value of an entity E's value domain, then E is returned.
d. If F matches partially with multiple entity names {E} or is contained (fully or partially) in multiple entity {E} value domain, then:
i. Compute a similarity metric, e.g., cosine similarity, between the user question and each entity name in {E}. Where the scores are denoted as {S}:
ii. Sort {S} in descending order and return the entity with the highest score.

### 3. To Disambiguate Dimensions:

a. Segregate dimension columns offline as columns that have:
i. Identifier or low cardinality description columns
ii. Column having filter conditions
iii. Time and other continuous columns that indicate trends
b. Cluster dimension columns that are correlated into logical dimension tables
i. Columns in a dimension table have a hierarchy, e.g., location dimension may have state, city, zip code, etc.
ii. A fragment to any of the column in the same dimension table is categorized in the same fragment
c. Create hash-based classifiers for dimension tables, dimension columns, and their value domains. The classifier is applied to lemmatize the keywords to their base form, e.g., the word “shipped” is lemmatized to “ship”; non-informative stop words observed in history are ignored, e.g., show, what, where, etc., before training.
d. The dimensions may be inferred as follows:
i. Dimension tables are matched to determine if there is a match
ii. If a match is not identified, dimension column names are matched
iii. Next, dimension column name aliases are matched to terms from ontology or from query history
iv. If not, try matching in dimension column value domain
v. If not, use a random forest classifier trained on past query history with manual labels may be utilized
e. A fragment can be disambiguated to multiple dimension tables, indicating that the tables may need to be joined in order to process the query.

### 4. To Disambiguate Measures:

a. Tokenize and create hash-based models on all measures from the ontology
b. For a fragment F, identify all tokens (sequence of strings) that have a partial or full match with the hash model
c. Group tokens that are overlapping, i.e., same sequence of string maps to different measures.
d. Rank measures for each group using the following features:
i. Percentage of measure that is matched, e.g., for each group
ii. The Levenstein distance of the token from the measure name provides an added metric, which may be determined
iii. A Poisson model of measure frequency seen in the past query history may be utilized
iv. A linear regression model that fits the above features using supervised learning may be utilized
e. The top ranked measure from each group is interpreted, while the others are provided to users and may serve as hints for reformulating the question.

### 5. To Disambiguate Functions:

a. Find the most similar set of data models that contain all disambiguated entities and measures and construct a join between them.
b. Use LLMs to infer the most relevant grouping of data, subject to the dimensions and measures selected.
c. Use LLMs to infer filters on one or more dimensions; all filter values must be valid with respect to the value domain.
d. Infer aggregations using semantics of the data, e.g., averages can only be averaged further, count can be summed or averaged, etc.

A fragmentation algorithm may be utilized to systematically deconstruct a query into various components and to utilize these components to generate contextually relevant and operationally accurate responses. An example fragmentation algorithm is described herein.

Identification of Query Components: The method commences with the identification of potential fragment types, herein referred to as components, inherent within a query. These components include, but are not limited to, the following: Dimensions, which refer to the spatial or measurable aspects of the query; Measures, which pertain to quantifiable elements within the query; Grouping, which relate to the classification or categorization of query elements; Aggregation, which involves the consolidation or combination of query elements; Ordering, which is associated with the sequence or arrangement of elements within the query; Advanced Analysis, which entails complex interpretive or evaluative aspects of the query.

Context Retrieval for Each Component: For each identified component, the method involves retrieving context relevant to the user's query. This is achieved through the following steps:
a. Selection of Synthetic Questions: Identifying the top-k synthetic questions exhibiting the maximum cosine similarity to the user's query. The parameter k may be configurable to a particular application and/or AI agent
b. Projection of Corresponding Components: Utilizing the identified synthetic questions to project corresponding components, which are then used as context.

Initial Component Generation: Subsequent to context retrieval, a Language Learning Model (LLM) is employed to generate an initial version of each component, utilizing the context obtained in the previous step.

Refinement and Operator Mapping: Each component is then refined, and corresponding fragments are mapped to actual operators, ensuring operational precision and relevance. The fragmentation method adopts a bottom-up approach, ensuring that the operators generated and employed are always correct and contextually appropriate.

Utilization of fragmentation enables a structured and efficient method for analyzing and processing queries through a fragmentation approach, ensuring accurate and contextually relevant responses.

FIG. 3B depicts an example workflow to perform guided table retrieval, in accordance with some implementations.

Reference is now made to FIG. 3B, which illustrates an end-to-end guided table retrieval pipeline 365 configured to identify tables and join paths needed to answer a natural language question over a structured database. The pipeline 365 decomposes the retrieval problem into four distinct phases: grounding, exploration, disambiguation, and merging that correspond to the illustrated steps 1-9.

Grounding Phase (Steps 1-3): The process initiates at Step 1, where a user question 366 is provided as a natural language string. At Step 2, the system utilizes hash-based predictors 370 to identify an initial set of target tables 374. The hash-based predictors 370 may be utilized to tokenize the question and generate linguistic variants (e.g., lemmas, synonyms, abbreviations, etc.) which are hashed and looked up in an inverted index mapping tokens to schema elements and sampled data values. If the initial target set 374 is insufficient (e.g., fewer than a threshold count k), Step 3 executes a semantic enrichment process. The large language model 382 embeds the user question, and the system retrieves additional tables from table embeddings 378 based on cosine similarity to precomputed embeddings of synthetic query contexts.

Exploration Phase (Step 4): At Step 4, the system performs a structural exploration of the database join graph using reachability graphs 378 (noting the numbering overlap with embeddings in some embodiments). For each table, a precomputed reachability set is used to determine which tables can serve as a “root” or source capable of reaching the initial targets 374. In some implementations, a reachability set R(t) is defined as the set of all tables reachable from a specific table t by following directed join edges representing foreign-key relationships. These relationships typically flow from parent fact tables toward child dimension tables. The system ranks candidate source tables by calculating a coverage score, which represents the intersection of the candidate's reachability set and the initial set of target tables 374. Tables with the highest coverage scores are prioritized as potential roots for the join tree.

Disambiguation Phase (Steps 5-8): At Step 5 and Step 6, the large language model 382 performs semantic disambiguation to identify the best source and destination(s) 384. The model 382 selects a single best source table and refines the initial targets into a final set of semantically relevant target tables, potentially pruning spurious matches or adding missing “bridge” tables. At Step 7, the system enumerates all paths from the best source 386 to each identified target in the context graph. Finally, at Step 8, the large language model 382 is tasked with selecting the best paths from the best source 388 based on the semantic role each path plays in answering the user question (e.g., distinguishing between a supplier's nation and a customer's nation).

Merging Phase (Step 9): At Step 9, the system algorithmically combines the selected paths into merged prefixes in topological order 390. The system extracts the minimal subtree (prefix) for each path and merges them by taking their union and deduplicating shared nodes and edges. Any trailing tables extending beyond the final target on a path are trimmed to ensure the join structure remains minimal. The resulting structure is a topologically ordered join tree, established by a join sequence where each table appears only after the tables it depends on, ensuring the output is directly consumable by a downstream query compiler.

The final stage of query construction involves synthesizing a topologically ordered join tree from the adjudicated join paths. Once a machine learning model selects the most relevant paths between the source table 386 and target tables 374, the system extracts minimal prefixes for each path. Merging is performed by taking the union of these prefixes and deduplicating shared nodes and edges within the context graph.

To ensure computational efficiency, the system algorithmically trims trailing tables that extend beyond the final target on any path, keeping the join structure as compact as possible. The resulting directed acyclic graph (DAG) is then sorted into a topological ordering. This established join sequence ensures that each table appears only after the tables it depends on, allowing the structure to be consumed directly by a query compiler to generate executable SQL without join-order errors.

The guided table retrieval pipeline provides several specific technical advantages over standard retrieval-augmented generation (RAG) and end-to-end large language model (LLM) approaches.

Reduction of Retrieval Brittleness through Decomposition: By decomposing the retrieval process into four distinct phases; grounding, exploration, disambiguation, and merging, the system avoids the brittleness and unpredictability of monolithic “black-box” LLM approaches. Each phase is assigned a specific responsibility: grounding provides determinism, exploration ensures structural coverage, disambiguation offers semantic reasoning, and merging provides structural coherence.

Elimination of Hallucinations via Data-Anchored Grounding: Unlike standard RAG methods that rely on surface-level keyword matching, the present system utilizes hash-based predictors to match query tokens against actual sampled data values stored in an inverted index. This deterministic anchoring ensures the system identifies relevant tables based on the actual contents of the database, significantly reducing the risk of “hallucinating” schema relationships that do not exist.

Guaranteed Join-Graph Reachability: The exploration phase systematically enumerates join-graph reachability using precomputed reachability sets. This provides a technological guarantee that the selected source table can physically reach all required target tables through valid foreign-key relationships, a structural constraint that standard semantic search models cannot enforce.

Syntactic Correctness through Topological Ordering: The merging phase does not merely list tables but algorithmically synthesizes a topologically ordered join tree. This ensures that the resulting join sequence respects all internal dependencies, allowing the output to be directly consumed by a query compiler without the execution errors common in LLM-generated SQL that may attempt to join tables in an invalid order.

Computational Efficiency via Minimal Join Trees: The system automatically extracts and merges minimal path prefixes, trimming any trailing tables that extend beyond the final semantically relevant targets. This ensures that the resulting query is as compact as possible, reducing computational overhead and preventing data duplication during relational join operations.

Superior Precision in Enterprise-Scale Environments: In evaluations on standard benchmarks, which feature noisy metadata and complex enterprise join topologies, the system achieved a 70% precision rate, representing an approximate 55% improvement over the 32% average precision achieved by state-of-the-art “top-k” retrieval baselines.

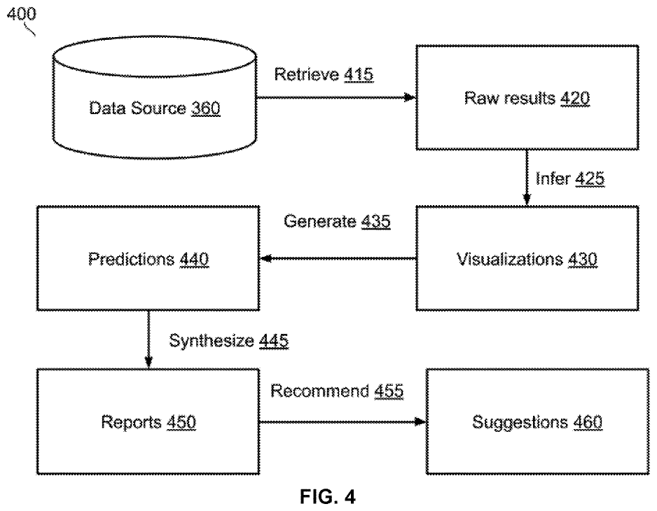

FIG. 4 depicts an example workflow to generate a response to business intelligence questions, in accordance with some implementations.

As depicted in FIG. 4, raw results (output results) 420 are retrieved (415) from a data source (360), e.g., as a response received to an executed query. One or more visualizations (430) may be inferred (425) based on the output results. Predictions (440) and/or forecasts may be generated (435). A set of visualizations (430) and predictions (440) may be synthesized (445) into one or more reports (450). Additionally, suggestions (460) may be recommended (455) to the user, e.g., based on observed trends, anomalies, cohort analysis, etc.

A response may be provided via multiple channels. In some implementations, a real-time response may be provided, and additional material may be made available to the user for subsequent retrieval.

Raw data is retrieved directly from the data source. Note that the results are always fresh and intermediate caching or materialized views can be used to speed up the response times.

Based on the data statistics, the most suitable visualizations of the raw data are inferred, e.g., low cardinality data may be better suited for pie charts, or continuous values may be preferably displayed as line charts, while discrete should be bar charts, and so on. The axes and their scaling may also be inferred, e.g., linear vs log.

Possible predictions are generated, either based on the question or on the data trends. Examples include outliers, anomalies, trends, forecasting, etc. Prediction algorithms typically involve a lot of parameter tuning, but the approach described herein may enable autotuning of those parameters based on the similarly observed (seen) data distributions.
Can show interesting patterns, e.g., anomaly, correlations, etc.
We then synthesize data and predictions into a report. These could include additional analysis such as cohort or summarization. We present them in a readable natural language form leveraging both generative AI and classical ML models.
Finally, recommendations are provided for taking actions or even for refining the question based on what other things that could be answered in that business domain and for that business instance.
The information generated by the business intelligence generator is presented to the user. Note that one more of the information may still be skipped/omitted depending on the user question and data/context available.

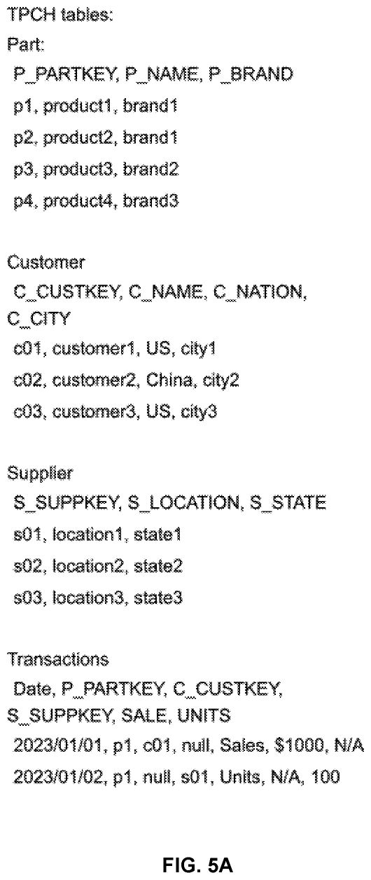

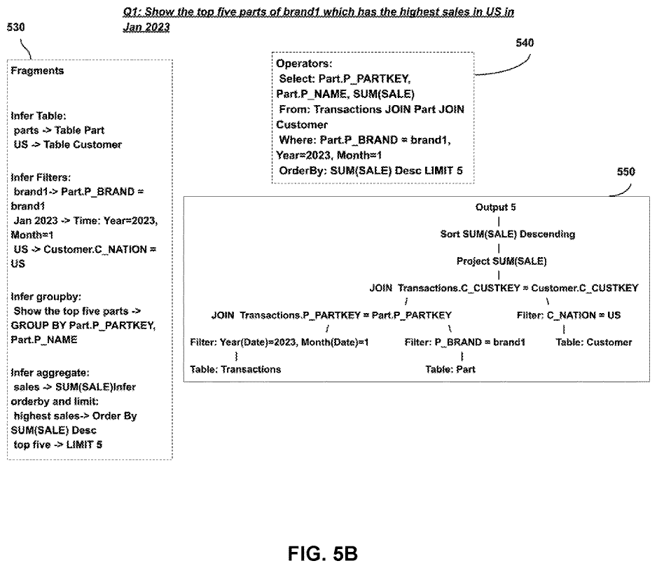

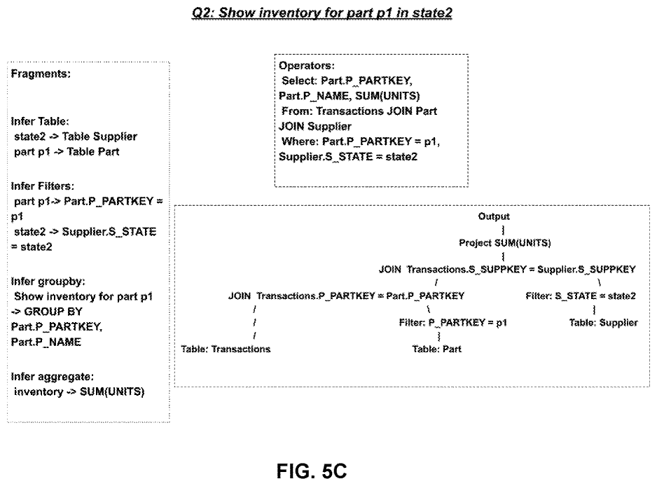

FIG. 5A depicts example elements of stored business data at a data source, in accordance with some implementations.

As depicted in FIG. 5A, the data source includes data elements relevant to the domain/enterprise; tables that include a listing of products, customers, suppliers, transactions, and associated attributes.

FIG. 5B depicts an example business intelligence question and corresponding fragments, operators, and a structured query tree, in accordance with some implementations.

As depicted in FIG. 5B, a question is posed by a user as a natural language string (“Show the top five parts of brand1 which has the highest sales in US in January 2023”). The natural language string is further decomposed into fragments 530 based on a large language model (LLM) and domain specific synthetic questions that are provided to the LLM for context.

Based on the fragments, query operators 540 are determined, from which a structured query tree 550 is constructed. The final result may be obtained by execution of the structured query tree (or execution of portions of the tree).

FIG. 5C depicts another example business intelligence question and corresponding fragments, operators, and a structured query tree, in accordance with some implementations.

FIG. 5C illustrates an example process for decomposing a natural language query into structured query components and a corresponding execution tree. In this illustrative example, the system processes the natural language input query, “Q2: Show inventory for part p1 in state2”.

As illustrated, the system identifies a plurality of Fragments from the natural language string to map linguistic elements to database schema. This includes:

Table Inference: The system determines that “state2” corresponds to the Supplier table and “part p1” corresponds to the Part table.

Filter Inference: The term “part p1” is mapped to a filter condition where Part. P_PARTKEY =p1, and “state2” is mapped to Supplier. S_STATE =state2.

Group-By and Aggregate Inference: The phrase “Show inventory for part p1” triggers a GROUP BY operation on the part key and name. Additionally, the system infers that “inventory” requires a SUM(UNITS) aggregate operation.

Following the fragment identification, the system defines specific Operators to construct a valid query. These operators include a Select clause for the part details and aggregated units, a From clause joining the Transactions, Part, and Supplier tables, and a Where clause applying the previously inferred filters.

Furthermore, FIG. 5C depicts a structured query tree representing the execution logic. At the base of the tree, the system accesses data from the Transactions, Part, and Supplier tables. Specific filters are applied to the Part and Supplier tables, specifically for part “p1” and state “state2 prior to performing relational JOIN operations. These joins are executed based on shared keys such as P_PARTKEY and S_SUPPKEY. The tree culminates in a Project operation for the calculated sum, resulting in the final Output provided to the user.

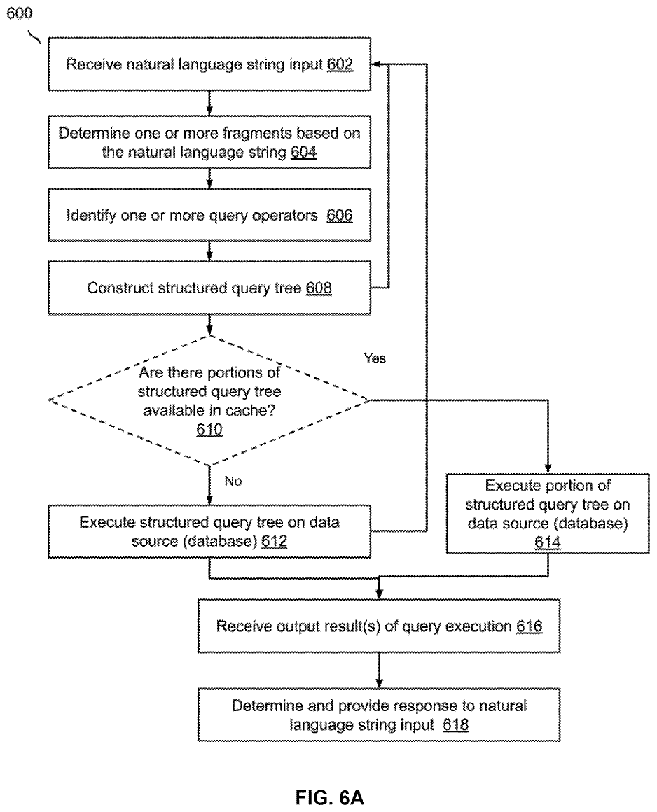

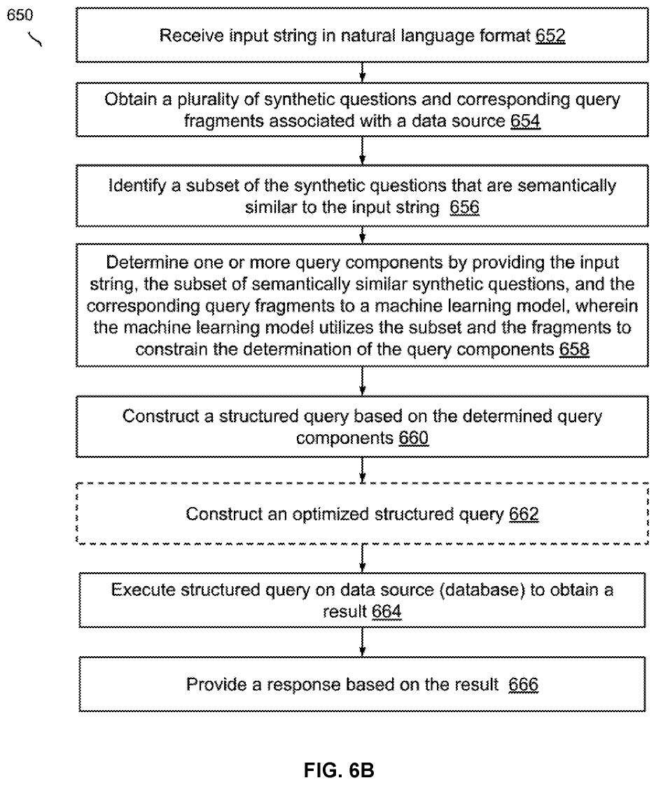

FIG. 6A depicts an example method to automatically generate a response to a business intelligence question, in accordance with some implementations.

In some implementations, method 600 (as well as methods 650, 700, 720, 730, 740, 750, 760, and/or 800 described in this specification) can be implemented, for example, on business intelligence system 110 described with reference to FIG. 1. In some implementations, some or all of the method 600 can be implemented on one or more client systems 120, on a distributed computing system 130, as shown in FIG. 1, and/or on a combination of the systems. In the examples described, the implementing system includes one or more digital processors or processing circuitry (“processors”), and one or more storage devices. In some implementations, different components of one or more distributed computing systems (e.g., cloud based systems), servers and/or clients can perform different blocks or other parts of the method 600. In some examples, a first device is described as performing blocks of method 600. Some implementations can have one or more blocks of method 600 performed by one or more other devices (e.g., other client devices or server devices) that can send results or data to the first device.

In some implementations, the method 600, or portions of the method, can be initiated automatically by a system. In some implementations, the implementing system is a first device. For example, the method (or portions thereof) can be periodically performed, or performed based on one or more particular events or conditions, e.g., receipt of a question via an application program interface (AI), reception of an event or notification, and/or messages from a cloud computing system, at a predetermined time, a predetermined time period having expired since the last performance of method 600, and/or one or more other conditions or events occurring which can be specified in settings processed by the a processor performing the method.

Method 600 may begin at block 602.

At block 602, a natural language string input is received, e.g., at a processor.

In some implementations, the natural language string input is a question posed by a user, and may be received at an artificial intelligence agent, e.g., similar to AI agent 160 described with reference to FIG. 1. In some implementations, receiving the question may include receiving the question at an artificial intelligence (AI) agent, wherein the AI agent is an instantiation of a plurality of machine learning models that are particular to a domain associated with a computing device that originated the question.

In some implementations, receiving the questions as the natural language string may include receiving an input via a voice to text converter. In some implementations, receiving the questions as the natural language string may include received text input received from a computing device of a user, wherein the user provides the natural language string input directly using the computing device.

Block 602 may be followed by block 604. At block 604, one or more fragments may be determined based on the natural language string. In some implementations, a tokenization technique may be applied to determine the one or more fragments.

In some implementations, the determination of the one or more fragments based on the natural language string may be performed as a single step process, whereas in some other implementations, the determination of the one or more fragments based on the natural language string may be performed as a multi-step process. In some implementations, determining the one or more fragments can include at least applying a large language model (language learning model or LLM) to the natural language string.

In some implementations, determining the one or more fragments can include reuse of fragments determined from (and associated with) previously received questions. For example, if a newly received question is similar (or identical) to a previously received question, previously generated fragments may be reused rather than determining corresponding fragments all over again. In some implementations, questions and corresponding fragments of frequently asked questions may be stored by the business intelligence system for efficient retrieval and reuse.

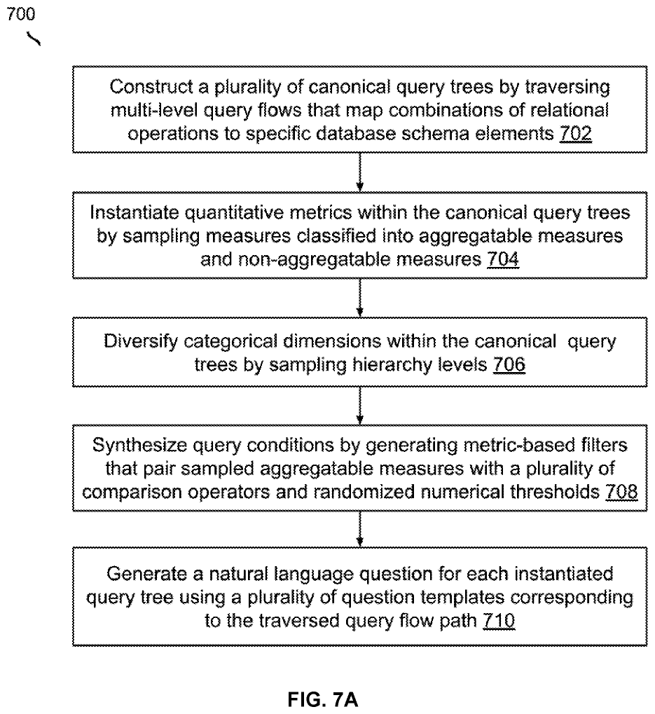

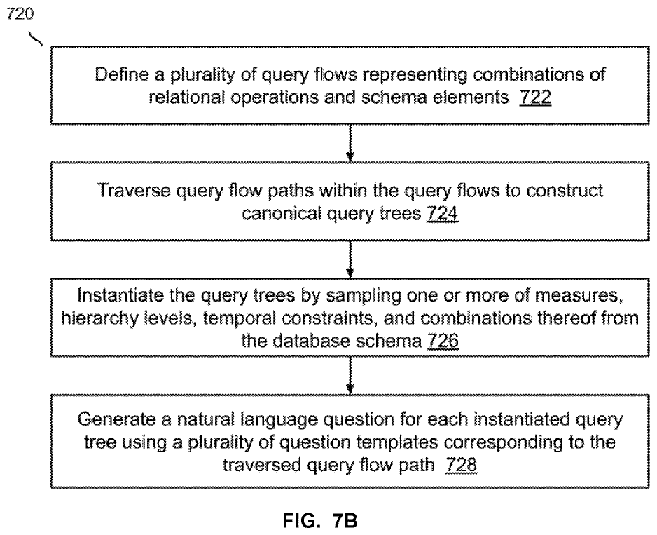

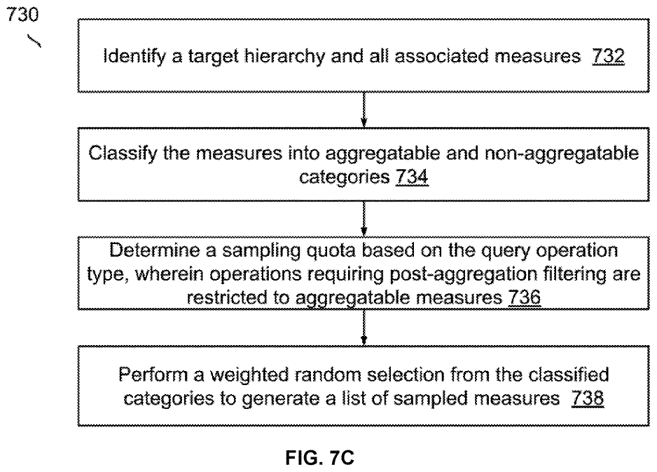

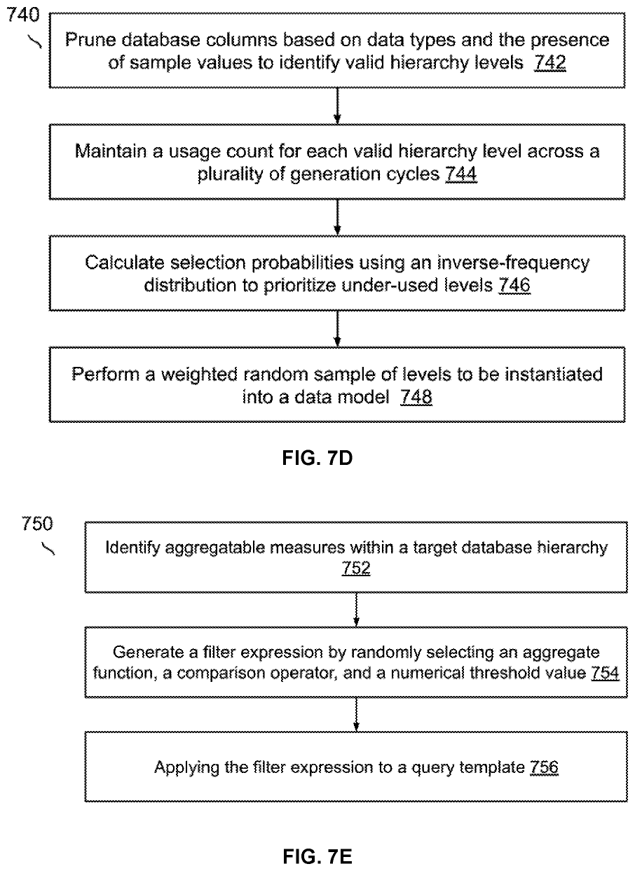

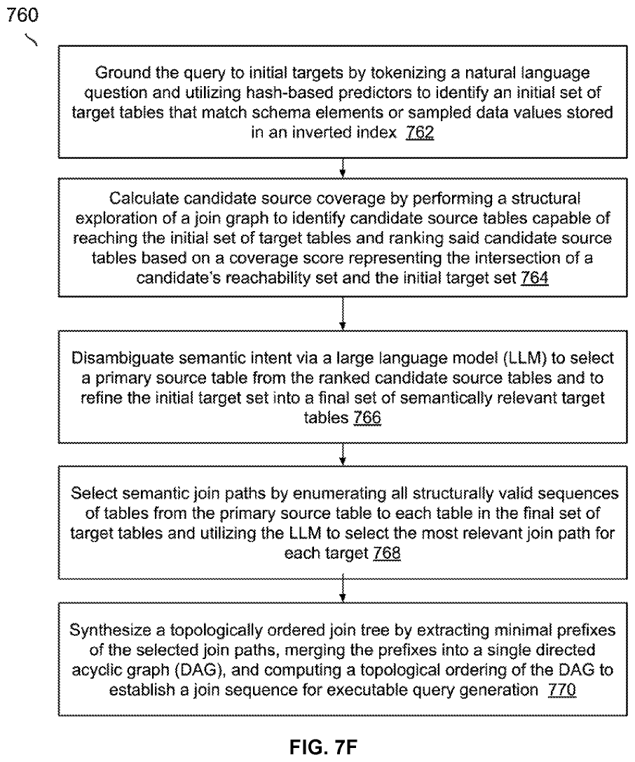

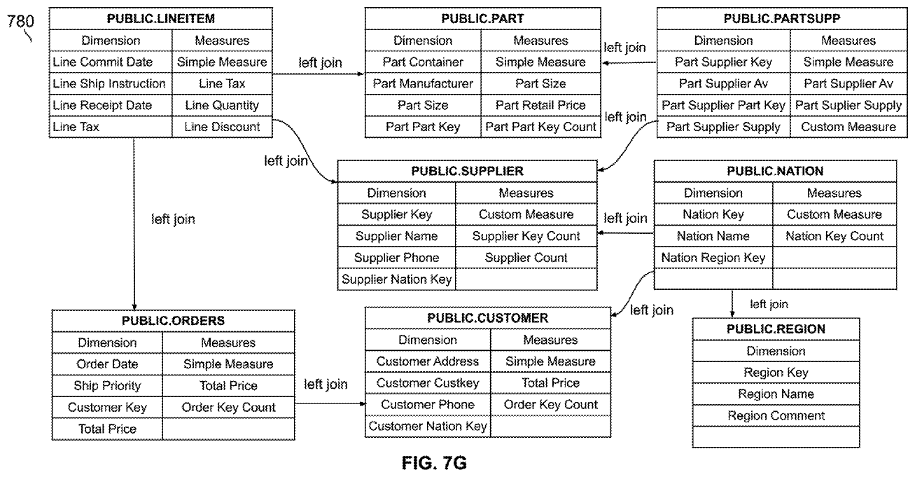

In some implementations, the one or more fragments may include overlapping fragments and/or non-overlapping fragments. In some implementations, determining the one or more fragments may further include providing synthetic questions that are similar to the natural language string to the large language model. The synthetic questions may be obtained from a set of synthetic questions that are previously generated based on the database schema. Generation of the synthetic questions is described subsequently with reference to FIG. 7.

In some implementations, determining the one or more fragments may further include filtering or constraining the fragments based on domain specific machine learning model(s). In some implementations, the constraints can include ontological constraints, domain specific constraints, dictionaries, inference models, mappings, etc.

In some implementations processing of the natural language string can include both exact and approximate matching techniques. Precise (exact) matching may be prioritized initially, followed by an exploration of approximate matching strategies when exact matches are unattainable. The integration of deterministic machine learning models and large language models (LLMs) in generating query operators based on natural language inputs is described herein.

Prioritization of Exact Match: Initially, the processing prioritizes exact matching. As articulated, if there exists a strict mapping between the question and the knowledge base, this exact mapping is the primary focus. If an exact match is successfully found, it is utilized; otherwise, the method may proceed to the next step.

Transition to Approximate Matching: In the absence of an exact match, the approach shifts to approximate matching. This involves a more flexible interpretation of the question, relaxing the strictness of the matching criteria. This process may be iterative, gradually adjusting the level of precision required for a match.

Employment of Synthetic Questions: The method involves the use of synthetic questions to facilitate the matching process. These questions, formulated based on the context of the input query, are posed to a large language model to mediate the generation of fragments. The LLM is tasked with interpreting these synthetic questions in a manner similar to known samples, thereby aiding in the generation of relevant query fragments.

Fragment Generation: Based on the input query, the method utilizes either a direct ontology mapping or an intermediate step involving synthetic questions. The generation of fragments is constrained, ensuring adherence to an established ontology. The ontology provides a framework for mapping, ensuring that fragments correspond to known and pre-existing categories.

Selection of Relevant Synthetic Questions: In real-time processing, from a larger set of sample synthetic questions, only the most pertinent ones are selected for analysis. This selection is based on relevance to the input query, ensuring efficient and accurate processing. The relevance may be ranked based on a similarity metric, e.g., a cosine similarity score between the question posed by the user and a set of synthetic questions.

In some implementations, a plurality of synthetic questions may be generated for respective domains based on metadata from ontology of the domains.

In some implementations, generating the plurality of synthetic questions for a particular domain comprises combining a plurality of fragments, wherein each fragment is generated based on components included in a data source associated with the particular domain.

Handling Overlapping Fragments: The method may utilize overlapping fragments. Overlapping fragments may enable addressing ambiguities within queries and enable a more nuanced interpretation.

Enforcement of Ontological Mapping: The process ensures that all generated fragments conform to the existing ontology associated with the domain and/or data sources. In the event that the LLM provides a fragment that is not included in a respective ontology, the response is realigned to the nearest existing term within the ontology. This enforces consistency and maintains the integrity of the response relative to the available knowledge base.

The generation of fragments mediated by the domain context balances the precision of exact matching with the flexibility of approximate matching, all within the confines of a predefined ontology. The methodology employs synthetic questions and large language models to interpret and generate query fragments, ensuring relevance and accuracy in real-time processing.

Block 604 may be followed by block 606. At block 606, one or more query operators may be identified based on the one or more fragments.

In some implementations, identifying the one or more query operators may include performing feature extraction on the one or more fragments. In some implementations, identifying the one or more query operators may include reuse of previously determined mappings of fragments to query operators.

Block 606 may be followed by block 608. At block 608, a structured query tree may be constructed (composed) based on the one or more query operators. In some implementations, constructing the structured query tree based on the one or more query operators may include constructing the structured query tree based on a target data source and/or domain specific constraints that are provided, e.g., via one or more synthetic questions.

In some implementations, block 608 may be followed by block 610. At block 610, it is determined whether output results that correspond to a portion of the structured query tree are available to the business intelligence system. If it is determined that output results that correspond to a portion of the structured query tree are available to the business intelligence system, then block 608 may be followed by block 614, else block 614 may be followed by block 612.

At block 612, the structured query tree is executed on a data source (database). In some implementations, the data source is a large data model generated from a primary data source. Block 612 may be followed by block 616.

At block 614, at least a portion of the structured query tree is executed on a data source. In some implementations, executing at least the portion of the structured query tree may include performing an optimized execution of the structured query tree. In some implementations, performing the optimized execution of the structured query tree may include determining whether portions of the structured query tree have been previously executed and wherein results from such execution are stored, e.g., in a cache or in a materialized form.

In some implementations, a freshness of previously stored output results may be determined prior to utilization. For example, it may be determined whether a portion of a structured query tree has been executed within a predetermined time frame and has results that have been cached and that are valid. In some implementations, a first operation that is performed may be to inspect the cache, and only results that are not stored may need execution of query operators on the database. In some implementations, the query processing results are stored and associated with various fragments. Block 614 may be followed by block 616.

At block 616, an output result may be received from the data source based on the execution of the structured query tree. Block 616 may be followed by block 618. At block 618, a response, e.g., to the question posed initially, may be generated based on the output result. The generated response may be provided to an output device and/or channel. In some implementations, the response may be provided via multiple channels and/or devices, including the via the same medium or channel that it was received from.

In some implementations, generating the response may include inferring one or more visualization elements based on the output result. In some implementations, a type of visualization elements may be determined based on a cardinality of data points in the output result.

In some implementations, one or more anomalies may be detected in the output result. In some implementations, output results that include time varying data, predictions and/or forecasts may be generated and provided to a user.

Blocks 602-618 can be performed (or repeated) in a different order than described above and/or one or more steps can be omitted. For example, in some implementations, blocks 610 may be omitted, and in some implementations, blocks 602-604 may be performed as a batch operation.

FIG. 6B depicts an example method to generate a response to a natural language input, in accordance with some implementations. FIG. 6B depicts an example method 650 to automatically generate a response to a natural language input, in accordance with some implementations.

In some implementations, method 650 can be implemented, for example, on the business intelligence system 110 described with reference to FIG. 1. The implementing system includes one or more digital processors or processing circuitry (“processors”) and one or more storage devices. Different components of one or more distributed computing systems, servers, or clients can perform different blocks or other parts of the method 650.

Method 650 may begin at block 652. At block 652, an input string is received in a natural language format. Similar to the implementations described for FIG. 6A, this input may be received at an artificial intelligence agent as a question posed by a user, originating from a computing device.

Block 652 may be followed by block 654. At block 654, the system obtains a plurality of previously generated synthetic questions and corresponding query fragments associated with a data source. These synthetic questions are representative of the semantics and data for a specific business domain and are used to provide context for answering business questions.

In some implementations, an automated pipeline may be utilized to generate a diverse and representative library of query context pairs, which typically include a canonical data model and a corresponding natural language question. This automated approach is designed to provide grounding context for natural language interfaces, e.g., a large language model (LLM) to improve the accuracy and reliability of SQL query generation over relational databases. By systematically synthesizing these pairs, the “cold start” problem associated with manually curating sample questions for complex enterprise schemas may be overcome.

In some implementations, the generation of synthetic questions may include generating a plurality of query flows representing combinations of relational operations and schema elements, traversing paths within (e.g., paths included in the query flows) the plurality of query flows to construct canonical query trees, instantiating the canonical query trees by sampling one or more of measures, hierarchy levels, temporal constraints, and combinations thereof from the database schema, and generating a natural language question for each instantiated canonical query tree using a plurality of question templates corresponding to the traversed query flow path.

In some other implementations, the generation of synthetic questions may include constructing a plurality of canonical query trees by traversing one or more query flow paths, e.g., those that represent patterns of data retrieval and analysis operations, instantiating the plurality of canonical query trees by sampling a representative set of quantitative measures and a representative set of categorical hierarchy levels from a database schema, synthesizing query conditions by generating metric-based aggregation filters that pair sampled aggregatable measures with randomized comparison operators and numerical thresholds, and translating each instantiated canonical query tree into a corresponding natural language question using a plurality of question templates associated with the traversed query flow path. The natural language questions (synthetic questions) may be utilized to provide grounding context for a natural language interface.

In some implementations, constructing the plurality of canonical query trees further comprises creating a base model utilizing a selected verb and a selected hierarchy. In some implementations, when the query flow path represents a trend-based retrieval pattern, hierarchies lacking temporal metadata may be omitted (skipped).

In some implementations, sampling the representative set of quantitative measures may include classifying measures into aggregatable measures and non-aggregatable measures. In some implementations, the method may further include calculating a sampling quota to ensure the inclusion of aggregatable measures for operations requiring post-aggregation filtering.

In some implementations, sampling the representative set of categorical hierarchy levels may further include pruning ineligible columns based on a data type and availability of sample values. In some implementations, inverse-frequency probabilities may be utilized to prioritize under-used levels to maximize database schema coverage. In some implementations, the sampling may include applying inverse-frequency probabilities to the representative set of categorical hierarchy levels, e.g., to select the representative set of categorical hierarchy levels.

In some implementations, synthesizing the query conditions may include attaching the generated metric-based aggregation filters to the plurality of question templates. In some implementations, a greedy diversification strategy may be utilized to attach the generated metric-based aggregation filters to the plurality of question templates. This may assist in ensuring inclusion of unique combinations of measures and levels within the query context library.

The system begins by defining a plurality of query flows that represent common patterns of data retrieval and analysis operations encountered in business intelligence. Each query flow maps specific combinations of relational operation, e.g., projection, aggregation, and filtering, to various schema elements, including dimensions and measures.

To construct a query context pair, the system systematically traverses paths defined by these query flows to construct canonical query trees. In some embodiments, constructing the canonical query tree involves creating a base model that utilizes a selected verb (e.g., “Show,” “List,” “Compare,” “Trend”, etc.) and a specific database hierarchy or primary table. The system may perform structural validation during traversal; for example, if the query flow path represents a trend-based retrieval pattern, the system may skip hierarchies that lack the necessary temporal metadata or date columns.

Once the query tree structure is established, the system instantiates the canonical query trees by sampling a representative set of quantitative measures, categorical hierarchy levels, and temporal constraints from the database schema.

To ensure mathematical and operational validity, the system employs a constrained measure sampling strategy. Measures associated with a target hierarchy are classified into aggregatable measures (e.g., total sales, which can be summed) and non-aggregatable measures (e.g., average rates, which may require different handling). The system calculates a sampling quota to ensure the inclusion of aggregatable measures when the query flow involves operations requiring post-aggregation filtering, such as “HAVING” clauses.

To maximize database schema coverage, the system diversifies the selection of categorical dimensions. This process includes pruning ineligible columns based on their data type or the lack of representative sample values. The system then applies inverse-frequency probabilities to the remaining valid levels, prioritizing those that have been under-utilized in previous generation cycles. Usage counts may be adjusted to balance future selections, ensuring that the generated query context library represents the entire database rather than only the most frequent columns.

Block 654 may be followed by block 656. At block 656, the system identifies a subset of the synthetic questions that are semantically similar to the input string. In some implementations, determining the subset of the synthetic questions that are semantically similar to the input string may include determining a cosine similarity score between the input string and the plurality of synthetic questions. In some implementations, the system identifies the top-k synthetic questions exhibiting the maximum cosine similarity to the user's query.

Block 656 may be followed by block 658. At block 658, the system determines one or more query components by providing the natural language input string, the subset of semantically similar synthetic questions, and the corresponding query fragments to a machine learning model. The machine learning model, such as a large language model (LLM), utilizes the provided subset and fragments to constrain the determination of the query components. This ensures that the operators generated are always correct and contextually appropriate relative to the established domain ontology.

In some implementations, determining the one or more query components may include providing the input string, the subset of semantically similar synthetic questions, and the corresponding query fragments to the ML model to obtain the query fragments corresponding to the input string, and processing each query fragment using the ML model to obtain the query component associated with each query fragment. For example, query components such as project, filter, aggregate, order, etc., may be determined by utilizing the ML model.

In some implementations, the ML model may include an unsupervised learning model, e.g., a classifier. In some other implementations, the ML model may include a deterministic model, e.g., an ANTLER-based model. In some implementations, a type of grammar in a query may be determined and then utilized to determine a type of ML model. For example, deterministic ML models may be better suited for well-defined grammar while unsupervised learning models may perform better for loosely defined grammar.

In some implementations, determining the one or more query components may include identifying one or more tables in the database schema by grounding the query by tokenizing a natural language question and utilizing hash-based predictors to identify an initial set of target tables matching schema elements or sampled data values, identifying candidate source tables by performing a structural exploration of a join graph to determine which tables can reach the initial set of target tables (e.g., query components), and ranking said candidate source tables based on a coverage score representing an intersection of a candidate's reachability set and the initial set of target tables, disambiguating semantic intent via a machine learning model to select a primary source table from the candidate source tables and to refine the initial set of target tables into a set of semantically relevant target tables, selecting join paths by enumerating all structurally valid sequences of tables from the primary source table to each target table and utilizing the machine learning model to select a semantically relevant path for each target, and synthesizing a topologically ordered join tree by merging prefixes of the selected join paths into a single directed acyclic graph.

In some implementations, following the selection of semantic join paths via large language model (LLM) adjudication, the system executes a merging phase to synthesize a single, compact join tree (J). This phase provides a technical solution to the inherent unpredictability of end-to-end LLM-generated join logic, which often produces redundant tables or incorrect join sequences that lead to execution errors. The system first performs prefix extraction, identifying the minimal subtree rooted at the selected source(s) that includes all tables on a specific path to a target (dᵢ). Formally, for a path P=[s, t₁, . . . , dᵢ], the system extracts the prefix(P)={s, t₁, . . . , dᵢ} and its associated edges.

To ensure the resulting join structure is minimal and computationally efficient, the system implements an automated trimming mechanism. During the merging of multiple prefixes, the system identifies and deduplicates shared nodes and edges. Crucially, the system analyzes each path to identify the position of the final semantically relevant target; any trailing tables that extend beyond the final target selected by the LLM are algorithmically trimmed. For example, as illustrated in a path [A, B, C, D] where the targets are T={B, F}, the system trims the path to [A, B], thereby preventing the inclusion of unnecessary trailing tables (C and D) in the final query. This trimming process reduces join complexity and prevents potential data duplication errors during SQL execution.

The union of these merged and trimmed prefixes forms a directed acyclic graph (DAG) rooted at the primary source table. The system then applies a topological ordering algorithm to the DAG to determine the exact sequence of relational joins. This ordering ensures that every table in the sequence is listed only after all tables upon which it has a join dependency have been established. This provides a structural guarantee of syntactical correctness, as the resulting topologically ordered join tree (J) can be directly consumed by a downstream query compiler without further join inference or filtering.

This multi-phase retrieval and synthesis approach transforms the construction of complex multi-table queries from a probabilistic “guess” into a deterministic, step-by-step technological process. By resolving semantic ambiguities via LLM reasoning while enforcing structural integrity through algorithmic merging and topological ordering, the system achieves a level of precision and “Perfect Recall” that monolithic models cannot consistently maintain, particularly in enterprise-scale environments with noisy metadata and complex join topologies.

Block 658 may be followed by block 660. At block 660, a structured query is constructed based on the determined query components. In some implementations, as shown in block 662, the system may further construct an optimized structured query to improve execution performance.

In some implementations, constructing the structured query may further include enumerating join-graph reachability for a plurality of tables in a context graph to identify a source table capable of reaching the one or more determined query components, utilizing a large language model to adjudicate between multiple candidate join paths connecting the source table to the query components, and algorithmically merging selected join paths into a minimal, topologically ordered join tree.

In some implementations constructing the structured query based on the determined query components may include constructing a first structured query based on the determined query components and subsequent to constructing the first structured query, rewriting the first structured query into a second structured query. The rewriting is performed while maintaining structural integrity of the query tree. For example, certain operations in the query tree may be modified while other operations in the query tree may not be modified.

In some implementations, the rewriting is performed such that the core join tree remains unchanged; it can add more subqueries, but the FROM clause in each one of them must obey the join graph. Filters, scalar, and/or window functions may be added only if they help to align more closely with the user intent; additional projects (e.g., base of derived columns) may be allowed since the rewriting augments the results.

Block 660 (or optional block 662) may be followed by block 664. At block 664, the system executes the structured query on a data source, such as a database, to obtain an output result.

In some implementations, executing the structured query on the data source may include performing an optimized execution of the structured query tree, and wherein performing the optimized execution comprises determining whether portions of the structured query tree have been previously executed, and that partial results exist in a cache on (or accessible to) the database. In such cases, only those portions of the structured query tree whose results are not available may be executed, and the results from the cache combined to provide a response to the query.

Finally, at block 666, the system provides a response based on the result obtained from the execution. This response may include tabular data, visualizations, or natural language summaries tailored to address the original query.

FIG. 7A describes an example method to generate synthetic questions associated with a database schema, in accordance with some implementations.

In some implementations, method 700 may be utilized to automatically generate a diverse query context library (e.g., via synthetic questions) to enhance a natural language database interface.

Method 700 may begin at block 702. At block 702, a plurality of canonical query trees may be constructed by traversing multi-level query flows that map combinations of relational operations. In some implementations, the relational operations may include projection, aggregation, filtering, etc., and may be applied to specific database schema elements. Block 702 may be followed by block 704.

At block 704, quantitative metrics may be instantiated within the query trees by sampling measures classified into aggregatable measures and non-aggregatable measures. In some implementations, measures for conditional aggregation operations may be restricted to aggregatable types to ensure mathematical validity. Block 704 may be followed by block 706.

At block 706, categorical dimensions within said query trees may be diversified by sampling hierarchy levels. The diversification may serve to prioritize under-utilized schema elements and maximize database coverage across a plurality of generation cycles. In some implementations, inverse-frequency selection probabilities may be utilized to perform the diversification. Block 706 may be followed by block 708.

At block 708, query conditions may be synthesized by generating metric-based filters that pair sampled aggregatable measures with a plurality of comparison operators and randomized numerical thresholds. Block 708 may be followed by block 710.

At block 710, a natural language question may be generated for each instantiated query tree using a plurality of question templates corresponding to the traversed query flow path. This may provide a grounding context for large language model query generation.

The system implements an automated pipeline to generate a diverse and representative set of data models and natural language question pairs to solve the “cold start” problem in natural language database interfaces. This pipeline is driven by four primary algorithms that systematically traverse database hierarchies and apply statistical sampling to ensure maximum schema coverage and operational validity.

The workflow described herein functions as a unified pipeline to transform a raw database schema into a comprehensive library of training examples, effectively solving the “cold start” problem for AI database interfaces. By automating this process, the system removes the need for experts to manually curate hundreds of SQL pairs. The collaboration follows a “bottom-up” construction process where a skeleton is built and then filled with increasingly complex data points.

FIG. 7B describes another example method for orchestrated data model generation to produce a query context library, in accordance with some implementations. FIG. 7B depicts an example method to systematically generate a diverse set of canonical query trees and corresponding natural language pairs, in accordance with some implementations.

FIG. 7B depicts an example method 720 for orchestrated data model generation to produce a query context library, in accordance with some implementations. In some implementations, method 720 can be implemented on the business intelligence system 110 described with reference to FIG. 1A. The pipeline is designed to transform a raw database schema into a comprehensive library of training examples to solve the “cold start” problem for natural language interfaces.

Method 720 may begin at block 722. At block 722, a plurality of query flows is defined representing combinations of relational operations and schema elements. These query flows serve as a structural blueprint, mapping specific operations such as projection, aggregation, and filtering to dimensions and measures to represent common patterns of data retrieval and analysis.

Block 722 may be followed by block 724. At block 724, the system traverses query flow paths within the defined query flows to construct canonical query trees. This systematic traversal defines the structural “skeleton” of a query. During this construction, the system may perform validation logic; for instance, the system may skip hierarchies lacking temporal metadata when a query flow path represents a trend-based retrieval pattern.

Block 724 may be followed by block 726. At block 726, the system instantiates the canonical query trees by sampling one or more of measures, hierarchy levels, temporal constraints, and combinations thereof from the database schema. In some implementations, this involves triggering specialized sub-routines to ensure mathematical and operational validity, such as classifying measures into aggregatable and non-aggregatable categories to ensure proper filtering. The system further maximizes schema coverage by utilizing inverse-frequency selection probabilities to prioritize under-used hierarchy levels.

Block 726 may be followed by block 728. At block 728, the system generates a natural language question for each instantiated query tree using a plurality of question templates corresponding to the traversed query flow path. This translation process pairs the constructed data model with a question phrased in a typical user format to provide grounding context for a natural language interface. By systematically synthesizing these diverse pairs, the system provides “step-by-step” guidance that enables large language models to understand enterprise-specific data patterns without manual human intervention.

In one implementation, the system utilizes a master generation algorithm to orchestrate the construction of canonical query trees. This algorithm systematically generates a diverse set of canonical query trees and corresponding natural language pairs. It iterates through defined query flows which map operations like aggregation, filtering, and sorting to specific schema elements and hierarchies. For each path, it samples measures and levels, attaches aggregation functions, and applies temporal or conditional constraints (like “top N” or date ranges). Finally, template-based generators are utilized to produce the equivalent natural language question for each constructed data model.

In some implementations, a method for generating a query context library for a relational database may include defining a plurality of query flows representing combinations of relational operations and schema elements, systematically traversing paths within said query flows to construct canonical query trees, instantiating said query trees by sampling measures, hierarchy levels, and temporal constraints from the database schema, and generating a natural language question for each instantiated query tree using a plurality of question templates corresponding to the traversed query flow path.

The workflow serves as an automated “question-and-answer” creator for a relational database. For example, instead of a person manually writing out every possible way a user might ask for data, this algorithm uses a set of templates (like “Show me [Metric] by [Category]”) and systematically plugs in different parts of the database. It mixes and matches actions (verbs), data points (measures), timeframes (calendars), and filters to create a library of examples that teach an AI how to understand real-world business questions.

Step 1: Orchestration (Algorithm 1) This acts as the master controller that navigates a 7-level “Query Flow”. It defines the structural “skeleton” of a query, deciding which combination of verbs, measures, hierarchies, and levels will be used in a single example.

The system initializes an empty repository for data models and iterates through a plurality of predefined query flow definitions and database hierarchies. For each hierarchy, the system determines the applicability of a specific query flow; for instance, “trend” flows are skipped if no date-related columns are identified within the target hierarchy. The algorithm triggers sub-routines to sample measures and levels, applying weighted selection strategies to populate the query structure. Statistical probabilities are applied during construction, such as a 50% probability weighting for “total” aggregations and varying distributions for “Compare” versus “Show” question verbs. The final model is produced by processing post-operations such as sorting, projecting, and applying “HAVING” clauses, followed by the generation of a natural language question using a template-based approach.

FIG. 7C describes an example method to sample quantitative metrics from a database schema to populate query templates, in accordance with some implementations.

FIG. 7C depicts an example method 730 for constrained measure sampling to ensure the mathematical and operational integrity of generated query contexts, in accordance with some implementations. In some implementations, method 730 can be implemented on the business intelligence system 110 described with reference to FIG. 1A. This specialized routine manages the selection of quantitative metrics for a given hierarchy while respecting operational constraints to prevent mathematical errors in the resulting queries.

Method 730 may begin at block 732. At block 732, the system identifies a target hierarchy and all associated measures within that hierarchy. These measures represent the numerical attributes in the data available for analysis, such as sales figures, revenue, quantities, etc.

Block 732 may be followed by block 734. At block 734, the system classifies the measures into aggregatable measures and non-aggregatable measures (categories). Aggregatable measures, often referred to as Level-1 measures, are those suitable for standard mathematical calculations and aggregations like sums. Non-aggregatable measures, or Level-2 measures, include those that may not be suitable for further summation, such as certain averages or identifiers.

Block 734 may be followed by block 736. At block 736, the system determines a sampling quota based on the query operation type, wherein operations requiring post-aggregation filtering are restricted to aggregatable measures. For example, if a query requires a “HAVING” clause, the system restricts selection strictly to aggregatable measures to ensure the resulting filter is mathematically valid. In some embodiments, the sampling limit is calculated based on the total available measures and a predefined limit according to the formula: limit=min(total_measures, 2 if postops else measure_limit)

Block 736 may be followed by block 738. At block 738, the system performs a weighted random selection from the classified categories to generate a list of sampled measures. This sampling strategy ensures that the generated query context provides a representative mix of column types and numeric data points available in the database schema. By systematically sampling these elements, the system populates the structural “skeleton” of the query with valid data to produce high-quality grounding context for natural language interfaces.

To ensure the mathematical integrity of the generated queries, the system employs a specialized measure sampling routine (e.g., Algorithm 2). Algorithm 2 manages the selection of quantitative metrics for a given hierarchy while respecting operational constraints. It categorizes measures into Level-1 (aggregatable) and Level-2 (non-aggregatable). If the query flow involves a “HAVING” clause, the algorithm strictly returns Level-1 measures to ensure mathematical validity. It uses a weighted random sampling strategy to fulfill a defined quota, ensuring that the sampled set provides a representative mix of column types available in the schema.

In some implementations, a method for sampling quantitative metrics from a database schema to populate query templates may include identifying a target hierarchy and identifying all associated measures, classifying said measures into aggregatable and non-aggregatable categories, determining a sampling quota based on the query operation type, wherein operations requiring post-aggregation filtering are restricted to aggregatable measures, and performing a weighted random selection from the classified categories to generate a list of sampled measures.

This workflow described herein with reference to FIG. 7C is a smart selector for numbers. If the system needs to generate a question about “sales” or “revenue,” this algorithm decides which specific numeric columns to use. It prioritizes columns that make sense to add up (like total dollars) but occasionally picks more complex ones (like averages or ratios) to ensure the AI is provided with coverage on all the types of numbers in the database.

Step 2: Populating the Numbers (Algorithm 2) When Algorithm 1 determines a “Measure” is needed, it calls Algorithm 2 to select specific numeric columns. Algorithm 2 ensures the numbers match the logic; for instance, if the query requires a “HAVING” clause, it strictly selects aggregatable measures to avoid mathematical errors.

Measures associated with a target hierarchy are classified into Level-1 (aggregatable) and Level-2 (non-aggregatable) categories. If a query requires a “HAVING” clause, the system restricts selection to Level-1 measures to ensure the resulting filter is mathematically valid.

The system calculates a sampling limit based on the total available measures and a specified limit, denoted by the formula limit=min(total_measures, 2 if postops else measure_limit). A random sampling strategy is executed from each category according to calculated quotas to ensure a representative mix of numeric data points.

FIG. 7D describes an example method to perform categorical dimension selection in automated query generation, in accordance with some implementations.

FIG. 7D depicts an example method 740 for diversifying categorical dimension selection in automated query generation to maximize database schema coverage, in accordance with some implementations. In some implementations, method 740 can be implemented on the business intelligence system 110 described with reference to FIG. 1A. This routine identifies and selects categorical hierarchy levels for grouping or filtering, ensuring that the resulting query context library represents the entire database rather than only the most frequently used columns.

Method 740 may begin at block 742. At block 742, the system prunes database columns based on data types and the presence of sample values to identify valid hierarchy levels. In this pruning step, the system excludes ineligible columns, such as date-type columns (which may be handled by separate calendar filters) or purely numeric columns.

Block 742 may be followed by block 744. At block 744, the system maintains a usage count for each valid hierarchy level across a plurality of generation cycles. This tracking mechanism allows the system to identify which categorical dimensions have been under-utilized in previously synthesized question-data model pairs.

Block 744 may be followed by block 746. At block 746, the system calculates selection probabilities, e.g., using an inverse-frequency distribution, to prioritize under-used levels. For the valid levels identified in the pruning step, the probability Pᵢ is defined as 1/usage_count. This inverse-frequency weighting provides a technical advantage by ensuring that schema elements with lower historical usage are assigned a higher selection probability in subsequent generation cycles.

Block 746 may be followed by block 748. At block 748, the system performs a weighted random sample of levels to be instantiated into a data model. In some embodiments, the system further adjusts the sample count to ensure adequate coverage if the desired count is less than a specific threshold of available levels, such as 25%. Additionally, a penalty system may be applied to specific level types, such as those ending in “id” or “number,” to prevent over-representation of technical identifiers. This comprehensive sampling strategy ensures a diverse and representative set of categorical levels is selected for the grounding context.

Algorithm 3 identifies and selects categorical dimensions for grouping or filtering. It first prunes the search space by excluding date columns (handled by calendar filters) and columns that contain purely numeric or missing values. To ensure maximum coverage and diversity, it calculates inverse-frequency probabilities, where levels used less frequently in prior generations are assigned a higher selection probability. It also applies a penalty/reward system to usage counts for specific column types (like IDs or counts) to balance future selections. In some implementations, to maximize schema coverage, the system utilizes an inverse-frequency sampling method for categorical dimensions (e.g., Algorithm 3).

In some implementations, a method for diversifying categorical dimension selection in automated query generation may include pruning database columns based on data types and the presence of sample values to identify valid hierarchy levels, maintaining a usage count for each valid hierarchy level across a plurality of generation cycles, calculating selection probabilities using an inverse-frequency distribution to prioritize under-used levels, and performing a weighted random sample of levels to be instantiated into a data model.

This algorithm acts as a smart selector for categories (like “Region” or “Product Name”). It looks through the database to find columns that aren't just raw numbers but are useful for grouping data. To make sure the AI doesn't just see the same common categories over and over, the algorithm purposefully looks for under-used columns, giving them a higher chance of being picked so that the resulting query examples cover the whole database fairly.

Step 3: Populating the Categories (Algorithm 3)When Algorithm 1 needs grouping levels or filter values, it triggers Algorithm 3. Algorithm 3 ensures schema coverage by using inverse-frequency weighting, meaning it purposefully selects under-used columns to ensure the AI learns the entire database, not just the most popular tables.

The system first prunes ineligible columns, such as date-type columns or purely numeric columns, from the hierarchy levels.

For the remaining valid levels, the system calculates selection probabilities, Pᵢ based on historical usage counts, defined as Pᵢ=1.0/usage_count.

This inverse-frequency weighting ensures that under-utilized levels are prioritized in subsequent generation cycles. The system further adjusts the sample count to ensure adequate coverage if the desired count is less than 25% of available levels. A penalty system is applied to specific level types, such as those ending in “number” or “id,” by artificially inflating their usage count to prevent over-representation.

Complexity is introduced into the data models through the automated synthesis of aggregation filters (e.g., Algorithm 4).

FIG. 7E describes an example method to synthesize conditional aggregation filters for a relational database query context, in accordance with some implementations.

FIG. 7E depicts an example method 750 for the automated synthesis of metric-based aggregation filters to introduce complexity into a query context library, in accordance with some implementations. In some implementations, method 750 can be implemented on the business intelligence system 110 described with reference to FIG. 1A. This method generates “HAVING-clause” style filters to increase the complexity and realism of the question-data model pairs used to ground a natural language interface.

Method 750 may begin at block 752. At block 752, the system identifies aggregatable measures within a target database hierarchy. These measures represent the numerical attributes of the data—such as sales, revenue, or quantity—that are suitable for standard mathematical aggregations.

Block 752 may be followed by block 754. At block 754, the system generates a filter expression by randomly selecting an aggregate function, a comparison operator, and a numerical threshold value. The system randomly pairs a sampled aggregatable measure with an aggregate function (e.g., SUM, AVG, MIN, MAX) and a comparison operator selected from a plurality of operators, such as {>, \ge, <, \le\}. To establish a filter boundary, the system generates a randomized numerical threshold value, typically ranging between 1 and 10,000. In some embodiments, depending on the available measure count, the system operates in either a “single” or “double” mode to apply one or two filter conditions, respectively.

Block 754 may be followed by block 756. At block 756, the system applies the filter expression to a query template. The system may utilize a greedy diversification strategy based on [measure, level] pairs to attach these filters to question templates. This technical approach ensures that the resulting query context library contains unique, non-redundant combinations of metrics and categorical dimensions, thereby maximizing the diversity and coverage of the grounding context provided to a large language model.

This algorithm generates “HAVING-clause” style filters to increase the complexity and realism of the query context. It selects aggregatable measures and randomly pairs them with an aggregation function and a comparison operator ($\{>, \ge, <, \le\}$). It generates a random threshold (e.g., between 1 and 10,000) to serve as a filter boundary. Finally, it uses a greedy diversification strategy to attach these filters to templates, ensuring that the same combinations of measures and levels are not over-represented.

In some implementations, a method for synthesizing conditional aggregation filters for a relational database query context may include identifying aggregatable measures within a target database hierarchy, generating a filter expression by randomly selecting an aggregate function, a comparison operator, and a numerical threshold value, and applying the filter expression to a query template. In some implementations, a greedy diversification strategy may be applied to ensure unique combinations of metrics and categorical levels.

This algorithm adds “conditions” to the questions to make them more realistic. Instead of just asking for “Sales by City,” it might create a question like “Sales by City where the total is greater than $10,000”. It randomly chooses math symbols (like “greater than” or “less than”) and sets random but plausible targets to teach the AI how to handle complex business requirements.

Step 4: Adding Complexity (Algorithm 4)Finally, Algorithm 4 is used to synthesize conditional filters (e.g., “where sales>10k”). It uses a “greedy diversification” strategy to ensure that the resulting question-and-answer pairs don't repeat the same patterns, maximizing the variety of the context provided to the LLM.

The system identifies aggregatable measures and randomly assigns them an aggregate function and a comparison operator selected from the set S {>, \ge, <, \le\}. A randomized numerical threshold is generated, typically between the values of 1 and 10,000, to serve as the filter boundary.

Depending on the available measure count, the system operates in either “single” or “double” mode to apply one or two filter conditions, respectively.

Finally, these filters are attached to existing templates using a greedy diversification strategy on the [measure, level] pair to ensure the generated query context is unique and non-redundant.

Solving the “Cold Start” Problem.

Traditionally, setting up a natural language interface required weeks of manual SQL writing. These algorithms work together to self-generate this context. By automatically creating diverse “data-model/question pairs,” they provide the “step-by-step” guidance an AI model needs to understand a specific enterprise's data patterns without human intervention.

FIG. 7F describes an example method to perform guided table retrieval for a database scheme, in accordance with some implementations.

FIG. 7F depicts an example method 760 for retrieving a structured join tree from a database join graph to resolve natural language queries, in accordance with some implementations. In some implementations, method 760 can be implemented on the business intelligence system 110 described with reference to FIG. 1A. This multi-phase pipeline provides a technical solution to the “brittleness” of standard large language model (LLM) approaches by decomposing retrieval into deterministic grounding, structural exploration, semantic disambiguation, and algorithmic merging.

Method 760 may begin at block 762. At block 762, the system grounds a query to initial targets by tokenizing a natural language question and utilizing hash-based predictors to identify an initial set of target tables. The hash-based predictors map tokens and their linguistic variants to schema elements or sampled data values stored in an inverted index, providing deterministic precision. In some implementations, a semantic fallback is applied if the initial target count is below a threshold, utilizing table embeddings derived from synthetic query contexts.

Block 762 may be followed by block 764. At block 764, the system calculates candidate source coverage by performing a structural exploration of a join graph to identify candidate source tables capable of reaching the initial set of target tables. Candidate source tables are ranked based on a coverage score representing the intersection of a candidate's precomputed reachability set and the initial target set.

Block 764 may be followed by block 766. At block 766, the system disambiguates semantic intent via an LLM to select a primary source table from the ranked candidate source tables and to refine the initial target set into a final set of semantically relevant target tables. This refinement allows the system to prune spurious matches or add necessary “bridge” tables that were not explicitly mentioned in the user question.

Block 766 may be followed by block 768. At block 768, the system selects semantic join paths by enumerating all structurally valid sequences of tables from the primary source table to each table in the final set of target tables. The LLM is utilized to select the most relevant join path for each target based on the context of the question, such as distinguishing between different semantic roles for the same table (e.g., a supplier's country versus a customer's country).

Block 768 may be followed by block 770. At block 770, the system synthesizes a topologically ordered join tree by extracting minimal prefixes of the selected join paths and merging them into a single directed acyclic graph (DAG). The system algorithmically trims trailing tables that extend beyond the final targets to maintain a minimal structure. Finally, a topological ordering of the DAG is computed to establish a join sequence that can be directly consumed by a downstream query compiler to generate executable SQL.

In some implementations, a method for retrieving a structured join tree from a database join graph in response to a natural language query may include grounding the query to initial targets by tokenizing a natural language question and utilizing hash-based predictors (or another type of deterministic mapping function) to identify an initial set of target tables that match schema elements or sampled data values stored in an inverted index, calculating candidate source coverage by performing a structural exploration of a join graph to identify candidate source tables capable of reaching the initial set of target tables and ranking said candidate source tables based on a coverage score representing the intersection of a candidate's reachability set and the initial target set, disambiguating semantic intent via a machine learning model to select a primary source table from the ranked candidate source tables and to refine the initial target set into a final set of semantically relevant target tables, selecting semantic join paths by enumerating all structurally valid sequences of tables from the primary source table to each table in the final set of target tables and utilizing the machine learning model to select a semantically relevant join path for each target, and synthesizing a topologically ordered join tree by extracting minimal prefixes of the selected join paths, merging said prefixes into a single directed acyclic graph (DAG), and computing a topological ordering of the DAG to establish a join sequence for executable query generation.

In some implementations, grounding the query may include applying a semantic fallback when the initial set of target tables is below a threshold count, the fallback comprising embedding the natural language question and retrieving tables based on cosine similarity to precomputed embeddings of synthetic query contexts.

In some implementations, the system implements a guided table retrieval pipeline to address the “brittleness” and hallucination risks inherent in end-to-end large language model (LLM) approaches. The first phase of this pipeline comprises deterministic grounding, which identifies an initial set of target tables (T₀) lexically or semantically connected to the user's question. Unlike traditional methods that rely solely on schema metadata, the present system maintains an inverted index that maps token variants—including lemmas, synonyms, and common abbreviations—to both schema elements (e.g., table names, column names, or aliases) and sampled data values.

The inclusion of sampled data values in the grounding index provides a technical advantage by “anchoring” the natural language query in the actual contents of the database. General-purpose LLMs frequently suffer from “black-box hallucinations” because they attempt to guess table relevancy based on surface-level keyword matching or abstract schema definitions, which are often abbreviated or semantically obscure. By contrast, the present system utilizes hash-based predictors to perform a deterministic lookup of query tokens against a repository of clean, representative sample values extracted during the data profiling stage. This ensures that if a user mentions a specific entity—such as a country name or a product ID—the system precisely identifies the correct table and column without requiring the LLM to “guess” the relationship.

For example, as illustrated in the processing of the query “Which Indian suppliers are shipping the most to China?”, the hash predictor identifies “Indian” and “China” as value matches within the NATION. N_NAME column, while “suppliers” is identified as a schema match on the SUPPLIER table. This deterministic grounding produces a high-precision initial target set. In instances where the hash predictor returns a target count below a configurable threshold (e.g., k=3), the system executes a semantic fallback. This fallback leverages precomputed embeddings derived from a table's synthetic query context, a set of representative questions the table is capable of answering and retrieves the most similar tables using cosine similarity.

By isolating the identification of data-relevant tables into a deterministic, algorithmic phase before involving LLM reasoning, the system significantly reduces the search space. This multi-step approach prevents the query compiler from attempting to generate SQL over irrelevant or “hallucinated” tables, thereby ensuring that the final executable query is both syntactically valid and semantically grounded in the underlying database reality.

In some implementations, the reachability sets for each table are precomputed and cached by following the direction of directed join edges representing foreign-key relationships from fact tables toward dimension tables.

In some implementations, selecting semantic join paths includes selecting multiple distinct join paths to a single table if said table occupies different semantic roles within the natural language query.

In some implementations, synthesizing the join tree further includes trimming trailing tables that extend beyond the final set of target tables to ensure the join tree remains minimal.

Blocks 760-770 can be performed (or repeated) in a different order than described above and/or one or more steps can be omitted.

FIG. 7G depicts an example TPC-H join graph, in accordance with some implementations.

A natural-language question such as “Which Indian suppliers are shipping the most to China?” requires navigating this graph to identify six tables and five joins, most of which are never mentioned explicitly in the question. Although the question mentions only suppliers and two countries, the correct query involves six tables and five joins and reveals several non-trivial retrieval challenges:

The Customer table is needed implicitly: “shipping to China” refers to customer locations, not a destination column. The Nation table appears twice in different roles—once for the supplier's nationality and once for the customer's—requiring contextual disambiguation. The Lineitem table is never mentioned by name, yet it provides the shipping metrics (quantity, order count) that are needed to answer the question. The Orders table serves purely as a bridge, connecting suppliers to customers through the join graph despite having no columns directly relevant to the question. Clearly, high-quality search over structured data must go beyond surface-level keyword matching: it needs to unpack the intent of a natural-language query into the relevant tables and their join relationships, taking into account both semantic context and the structure of the join graph.

Techniques described herein may be utilized to determine a suitable SQL query, as provided below.
SELECT S. S_NAME AS Supplier_Name,
SUM (L. L_QUANTITY) AS Total_Quantity,
COUNT (DISTINCT L. L_ORDERKEY) AS Distinct_Orders
FROM LINEITEM L
JOIN SUPPLIER S ON L. L_SUPPKEY=S. S_SUPPKEY
JOIN NATION SN ON S. S_NATIONKEY=SN. N_NATIONKEY
JOIN ORDERS O ON L. L_ORDERKEY=O. O_ORDERKEY
JOIN CUSTOMER C ON O. O_CUSTKEY=C. C_CUSTKEY
JOIN NATION CN ON C. C_NATIONKEY=CN. N_NATIONKEY
WHERE SN. N_NAME=‘INDIA’
AND CN. N_NAME=‘CHINA’
GROUP BY S. S_NAME
ORDER BY Total_Quantity DESC;

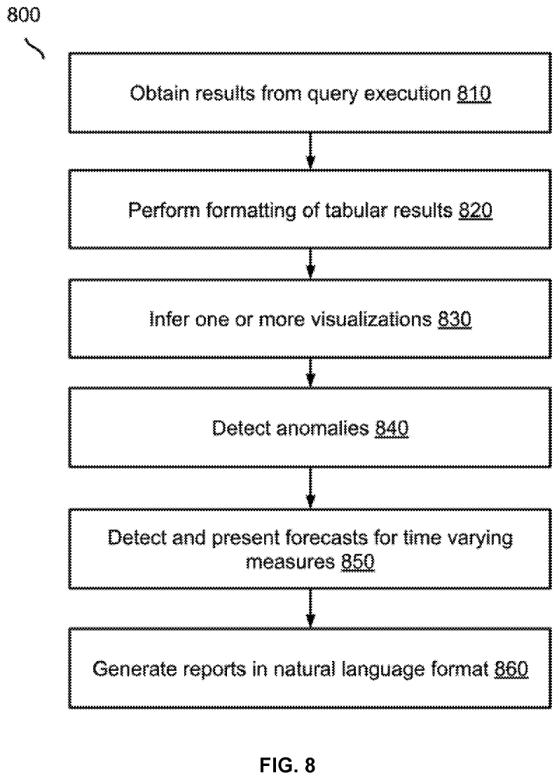

FIG. 8 depicts another example method to automatically generate a response to a business intelligence question, in accordance with some implementations.

In some implementations, method 800 can be implemented, for example, on business intelligence system 110 described with reference to FIG. 1. In some implementations, some or all of the method 800 can be implemented on one or more client systems 120, on a distributed computing system 130, as shown in FIG. 1, and/or on a combination of the systems. In the examples described, the implementing system includes one or more digital processors or processing circuitry (“processors”), and one or more storage devices. In some implementations, different components of one or more distributed computing systems (e.g., cloud based systems), servers and/or clients can perform different blocks or other parts of the method 800. In some examples, a first device is described as performing blocks of method 800. Some implementations can have one or more blocks of method 800 performed by one or more other devices (e.g., other client devices or server devices) that can send results or data to the first device.

Method 800 may begin at block 810. At block 810, output results may be obtained from a data source in response to execution of a query.

Block 810 may be followed by block 820. At block 820, any tabular results obtained are suitably formatted. For example:
a. Transpose multiple measures in rows as columns for better presentation
i. This means some cells might be empty since not all measures may have values available for all dimension points.
b. Human readable headers for measures and aggregates

Block 820 may be followed by block 830. At block 830, one or more visualizations may be inferred based on the obtained output results.
a. Low cardinality and categorical data points are shown as pie chart
b. Continuous time-series results are visualized as line charts
c. Discrete and other results are visualized as bar chart
d. Infer aspects of data values such as currency, percentage, scientific notation, and human readable separators, e.g., separators for a thousandth place in a number.
e. Adjust the scaling to linear or logarithmic based on the range and variance of y-values

Block 830 may be followed by block 840. At block 840, anomalies in the output results are detected. For example, a shift of data points from usually observed (normal) anchor points may be detected. In some implementations, anomalous points are detected and provided to the user along with a response, if available. In some implementations, anomaly detection may be tuned using data distributions of similarly obtained data results in the past.

Block 840 may be followed by block 850. At block 850, for questions and/or output results that include time varying data, forecasts may be determined and presented.

Block 850 may be followed by block 860. At block 860, reports may be generated, e.g., in natural language format, by applying the results to a large language model.

In some scenarios, descriptive reports may be generated for the results, summarizing them in natural language both in terms of data properties and statistics, and in terms of additional anomaly or forecasting inference.

In some scenarios, suggestions may be collected for alternate phrasing of the question, e.g., other lower ranked measures, dimensions, etc.

Blocks 810-860 can be performed (or repeated) in a different order than described above and/or one or more steps can be omitted. For example, in some implementations, any one or more of blocks 820-860 may be omitted, e.g., based on user preferences, use context, etc.

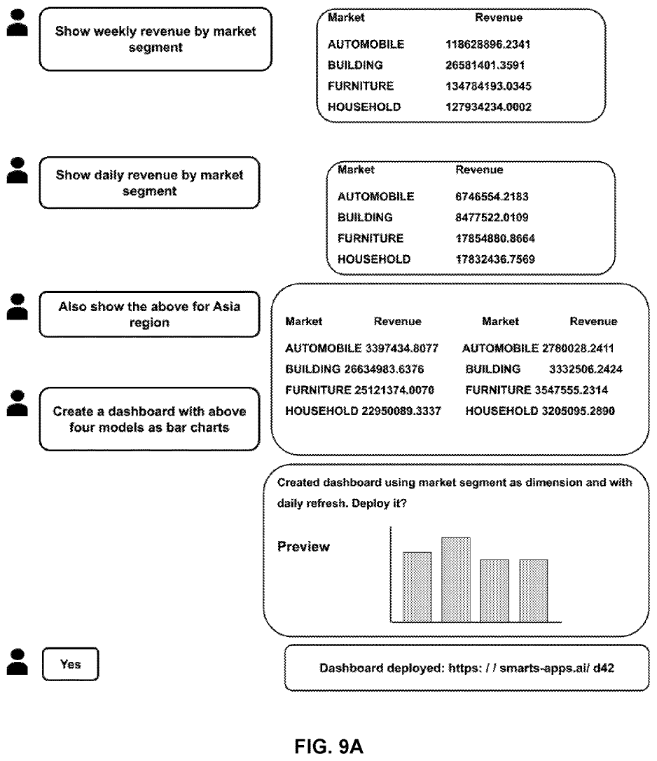

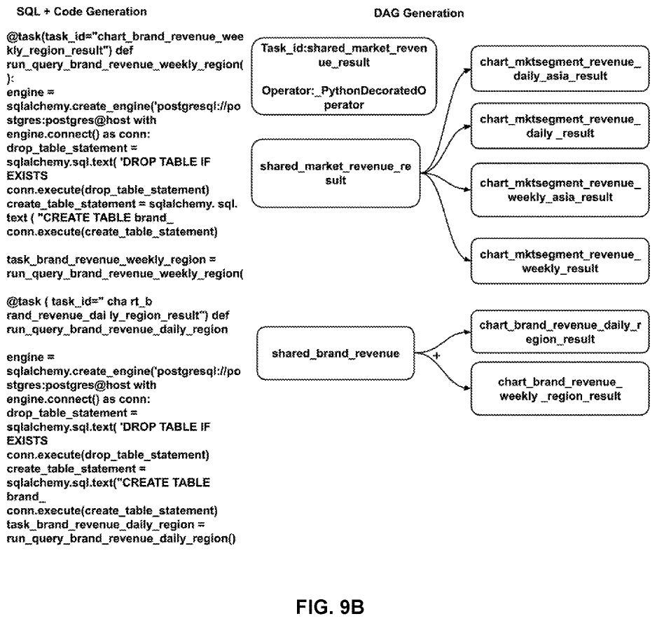

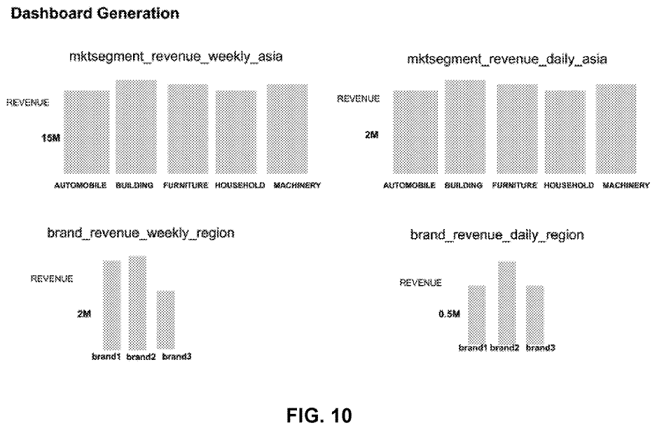

FIG. 9A depicts an example of generative actions based on user conversation, in accordance with some implementations.

FIG. 9A illustrates an exemplary user interface and conversational flow for generating business intelligence insights and deploying automated dashboards. In this implementation, a user interacts with the system via a conversational interface (such as the one shown in FIG. 1D) by providing natural language inputs to query data and perform actions.

As shown, the user may initiate a query such as “Show weekly revenue by market segment”. The system processes this natural language string to retrieve data and present a tabular response including market categories (e.g., AUTOMOBILE, BUILDING, FURNITURE, HOUSEHOLD) and their corresponding revenue figures. Subsequent queries, such as “Show daily revenue by market segment” or regional filters like “Also show the above for Asia region,” demonstrate the system's ability to maintain context and refine results across multiple turns of conversation.

Furthermore, FIG. 9A depicts the transition from data exploration to application deployment. Upon the user's request to “Create a dashboard with above four models as bar charts,” the system generates a preview of the visualization and asks for deployment confirmation. Following a final affirmative input (e.g., “Yes”), the system confirms the dashboard is deployed and provides a network address (URL) for accessing the live, refreshing dashboard.

FIG. 9B depicts example code generation, in accordance with some implementations.

FIG. 9B illustrates the backend technical execution, specifically for SQL and code generation and DAG (Directed Acyclic Graph) generation that occurs in response to the user interactions described in FIG. 9A.

The left portion of FIG. 9B shows automatically generated code designed to execute the requested business logic. This includes task definitions using @task decorators, which are configured to interface with a database via an engine (e.g., sqlalchemy). The generated code manages data lifecycle operations, such as dropping existing tables, creating new brand-specific tables, and executing the core analytical queries to populate those tables.

The right portion of FIG. 9B illustrates the orchestration layer through the generation of DAGs. These DAGs define the dependencies between data processing tasks. For example:

A shared market revenue task (shared_market_revenue_result) serves as a parent node for multiple visualization tasks, including daily and weekly revenue results for both global and Asia-specific segments. A shared brand revenue task (shared_brand_revenue) is linked to daily and weekly regional results.

This automated workflow generation ensures that the natural language requests from FIG. 9A are translated into scalable, repeatable, and orchestrated data pipelines capable of supporting daily refreshes and live dashboarding.

FIG. 10 depicts example dashboards, in accordance with some implementations.

FIG. 10 illustrates an exemplary graphical user interface representing the dashboard generation phase of the system. In this implementation, the dashboard comprises a plurality of visualizations, such as bar charts, which correspond to the analytical tasks and models defined in the preceding stages (e.g., as shown in FIG. 9A and FIG. 9B).

The illustrated dashboard includes four distinct visualizations:

Weekly Market Segment Revenue (Asia): A bar chart titled mktsegment_revenue_weekly_asia. The vertical axis represents REVENUE with a sample scale of 15M. The horizontal axis displays categorical dimensions including AUTOMOBILE, BUILDING, FURNITURE, HOUSEHOLD, and MACHINERY.

Daily Market Segment Revenue (Asia): A bar chart titled mktsegment_revenue_daily_asia. This chart utilizes the same categorical dimensions on the horizontal axis but displays revenue on a daily granularity, with a sample scale of 2M.

Weekly Brand Revenue (Region): A bar chart titled brand_revenue_weekly_region. The vertical axis represents revenue with a scale of 2M. The horizontal axis differentiates revenue across specific entities, labeled as brand1, brand2, and brand3.

Daily Brand Revenue (Region): A bar chart titled brand_revenue_daily_region. This chart provides a high-frequency view of brand performance, with a sample revenue scale of 0.5M for the same brand entities.

These visualizations collectively demonstrate the system's ability to automatically synthesize complex data queries into a cohesive, multi-dimensional business intelligence dashboard for end-user consumption.

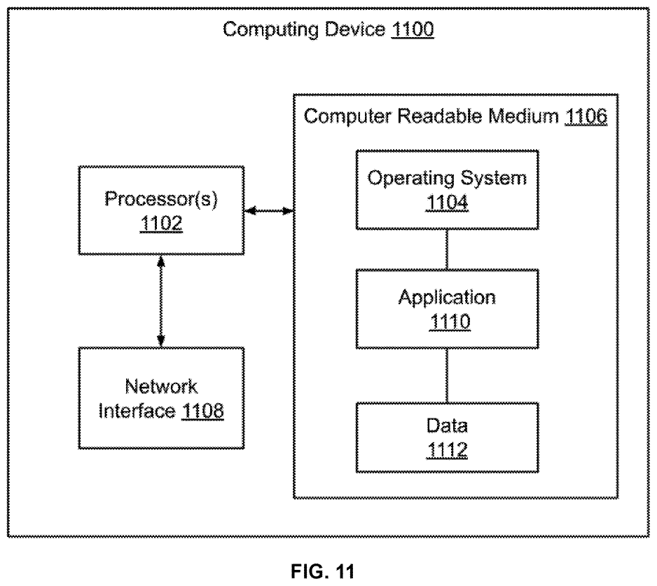

FIG. 11 depicts an example computing device, in accordance with some implementations.

FIG. 11 is a block diagram of an example computing device 1100 which may be used to implement one or more features described herein. In one example, device 1100 may be used to implement a computer device (e.g. 110, 120, 130, and/or 150 of FIG. 1) and perform appropriate method implementations described herein. Computing device 1100 can be any suitable computer system, server, or other electronic or hardware device. For example, the computing device 1100 can be a compute resource on a cloud, a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, device 1100 includes a processor 1102, a memory or computer readable medium 1106, and network (input/output (I/O)) interface 1108.

Processor 1102 can be one or more processors and/or processing circuits to execute program code and control basic operations of the device 1100. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Computer readable medium (memory) 1106 is typically provided in device 1100 for access by the processor 1102, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 1102 and/or integrated therewith. Memory 1106 can store software operating on the device 1100 by the processor 1102, including an operating system 1104, one or more applications 1110 and application data 1112. In some implementations, application 1110 can include instructions that enable processor 1102 to perform the functions (or control the functions of) described herein.

Elements of software in memory 1106 can alternatively be stored on any other suitable storage location or computer-readable medium. In addition, memory 1106 (and/or other connected storage device(s)) can store instructions and data used in the features described herein. Memory 1106 and any other type of storage (magnetic disk, optical disk, magnetic tape, or other tangible media) can be considered “storage” or “storage devices.”

A network or I/O interface can provide functions to enable interfacing the server device 1100 with other systems and devices. For example, network communication devices, storage devices, and input/output devices can communicate via the interface. In some implementations, the I/O interface can connect to interface devices including input devices (keyboard, pointing device, touchscreen, microphone, camera, scanner, etc.) and/or output devices (display device, speaker devices, printer, motor, etc.).

For ease of illustration, FIG. 11 shows a single representation (block) of processor 1102 and memory 1106. These blocks may represent one or more processors or processing circuitries, operating systems, memories, I/O interfaces, applications, and/or software engines. In other implementations, device 1100 may not have all of the components shown and/or may have other elements including other types of elements instead of, or in addition to, those shown herein. While the processing system 130 is described as performing operations as described in some implementations herein, any suitable component or combination of components of processing system 130 or similar system, or any suitable processor or processors associated with such a system, may perform the operations described.

A user device can also implement and/or be used with features described herein. Example user devices can be computer devices including some similar components as the device 1100, e.g., processor(s) 1102, memory 1106, etc. An operating system, software and applications suitable for the client device can be provided in memory and used by the processor. The I/O interface for a client device can be connected to network communication devices, as well as to input and output devices, e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices. A display device within the audio/video input/output devices, for example, can be connected to (or included in) the device 1100 to display images pre-and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices. In another example, all computations can be performed on a distributed computing system, e.g., a cloud based computing system.

Although the description has been described with respect to particular implementations thereof, these particular implementations are merely illustrative. Concepts illustrated in the examples may be applied to other examples and implementations.

The functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

1. A computer-implemented method to generate a response to a natural language input, comprising:
receiving an input string in a natural language format;
obtaining a plurality of synthetic questions and corresponding query fragments associated with a data source;
identifying a subset of the synthetic questions that are semantically similar to the input string;
determining one or more query components by providing the input string, the subset of semantically similar synthetic questions, and the corresponding query fragments to a machine learning (ML) model, wherein the ML model utilizes the subset and the fragments to constrain the determination of the query components;
constructing a structured query based on the determined query components;
executing the structured query on the data source to obtain a result; and
providing a response based on the result.

2. The computer-implemented method of claim 1, further comprising generating the plurality of synthetic questions for a database schema by:
generating a plurality of query flows representing combinations of relational operations and schema elements;
traversing query flow paths within the plurality of query flows to construct canonical query trees;
instantiating the canonical query trees by sampling one or more of measures, hierarchy levels, temporal constraints, and combinations thereof from the database schema; and
generating a natural language question for each instantiated canonical query tree using a question template corresponding to the traversed query flow path.

3. The computer-implemented method of claim 1, wherein the plurality of synthetic questions are generated by:
constructing a plurality of canonical query trees by traversing one or more query flow paths;
instantiating the plurality of canonical query trees by sampling a representative set of quantitative measures and a representative set of categorical hierarchy levels from a database schema;
synthesizing query conditions by generating metric-based aggregation filters that pair sampled aggregatable measures with randomized comparison operators and numerical thresholds; and
translating each instantiated canonical query tree into a corresponding natural language question using a plurality of question templates associated with a corresponding query flow path.

4. The computer-implemented method of claim 3, wherein constructing the plurality of canonical query trees further comprises creating a base model utilizing a verb and a hierarchy to construct the canonical query trees during the traversing.

5. The computer-implemented method of claim 4, further comprising skipping the hierarchy if it lacks temporal metadata.

6. The computer-implemented method of claim 3, wherein sampling the representative set of quantitative measures further comprises classifying measures into aggregatable measures and non-aggregatable measures.

7. The computer-implemented method of claim 3, wherein sampling the representative set of categorical hierarchy levels further comprises pruning ineligible columns based on a data type and availability of sample values.

8. The computer-implemented method of claim 7, wherein the sampling comprises applying inverse-frequency probabilities to the representative set of categorical hierarchy levels.

9. The computer-implemented method of claim 3, wherein synthesizing the query conditions further comprises attaching the generated metric-based aggregation filters to the plurality of question templates.

10. The computer-implemented method of claim 9, wherein attaching the generated metric-based aggregation filters to the plurality of question templates comprises utilizing a greedy diversification strategy.

11. The computer-implemented method of claim 1, wherein determining the one or more query components further comprises identifying one or more tables in a database schema by:
grounding the input string by tokenizing the input string and utilizing hash-based predictors to identify an initial set of target tables matching schema elements or sampled data values;
identifying candidate source tables by performing a structural exploration of a join graph to determine which tables can reach the initial set of target tables, and ranking said candidate source tables based on a coverage score representing an intersection of a reachability set of each candidate source table and the initial set of target tables;
disambiguating semantic intent via the ML model to select a primary source table from the candidate source tables and to refine the initial set of target tables into a set of semantically relevant target tables;
selecting join paths by enumerating all structurally valid sequences of tables from the primary source table to each target table and utilizing the ML model to select a semantically relevant path for each of the semantically relevant target tables; and
synthesizing a topologically ordered join tree by merging prefixes of the selected join paths into a single directed acyclic graph.

12. The computer-implemented method of claim 1, wherein constructing the structured query further comprises:
enumerating join-graph reachability for a plurality of tables in a context graph to identify a source table capable of reaching the one or more determined query components;
selecting join paths by utilizing a large language model to adjudicate between multiple candidate join paths connecting the source table to the query components; and
algorithmically merging the selected join paths into a minimal, topologically ordered join tree.

13. The computer-implemented method of claim 1, wherein determining the subset of the synthetic questions that are semantically similar to the input string comprises determining a cosine similarity score between the input string and the plurality of synthetic questions.

14. The computer-implemented method of claim 1, wherein constructing the structured query based on the determined query components comprises constructing a first structured query based on the determined query components and subsequent to constructing the first structured query, rewriting the first structured query into a second structured query.

15. The computer-implemented method of claim 1, wherein determining the one or more query components comprises:
providing the input string, the subset of semantically similar synthetic questions, and the corresponding query fragments to the ML model to obtain the query fragments corresponding to the input string; and
processing each query fragment using the ML model to obtain the query component associated with each query fragment.

16. A non-transitory computer-readable medium comprising instructions that, responsive to execution by a processing device, cause the processing device to perform operations comprising:
receiving an input string in a natural language format;
obtaining a plurality of synthetic questions and corresponding query fragments associated with a data source;
identifying a subset of the synthetic questions that are semantically similar to the input string;
determining one or more query components by providing the input string, the subset of semantically similar synthetic questions, and the corresponding query fragments to a machine learning model, wherein the machine learning model utilizes the subset and the fragments to constrain the determination of the query components;
constructing a structured query based on the determined query components;
executing the structured query on the data source to obtain a result; and
providing a response based on the result.

17. The non-transitory computer-readable medium of claim 16, the operations further comprising generating the plurality of synthetic questions by:
constructing a plurality of canonical query trees by traversing query flow paths that represent patterns of data retrieval and analysis operations;
instantiating the plurality of canonical query trees by sampling a representative set of quantitative measures and a representative set of categorical hierarchy levels from a database schema;
synthesizing query conditions by generating metric-based aggregation filters that pair sampled aggregatable measures with randomized comparison operators and numerical thresholds; and
translating each instantiated canonical query tree into a corresponding natural language question using a plurality of question templates associated with a corresponding query flow path.

18. The non-transitory computer-readable medium of claim 16, wherein constructing the structured query further comprises:
enumerating join-graph reachability for a plurality of tables in a context graph to identify a source table capable of reaching the one or more determined query components;
selecting join paths by utilizing a large language model to adjudicate between multiple candidate join paths connecting the source table to the query components; and
merging the selected join paths into a minimal, topologically ordered join tree.

19. A system comprising:
a memory with instructions stored thereon; and
a processing device, coupled to the memory, the processing device configured to access the memory and execute the instructions, wherein the instructions cause the processing device to perform operations including:
receiving an input string in a natural language format;
obtaining a plurality of synthetic questions and corresponding query fragments associated with a data source;
identifying a subset of the synthetic questions that are semantically similar to the input string;
determining one or more query components by providing the input string, the subset of semantically similar synthetic questions, and the corresponding query fragments to a machine learning model, wherein the machine learning model utilizes the subset and the fragments to constrain the determination of the query components;
constructing a structured query based on the determined query components;
executing the structured query on the data source to obtain a result; and
providing a response based on the result.

20. The system of claim 19, the operations further comprising generating the plurality of synthetic questions by:
constructing a plurality of canonical query trees by traversing query flow paths that represent patterns of data retrieval and analysis operations;
instantiating the plurality of canonical query trees by sampling a representative set of quantitative measures and a representative set of categorical hierarchy levels from a database schema;
synthesizing query conditions by generating metric-based aggregation filters that pair sampled aggregatable measures with randomized comparison operators and numerical thresholds; and
translating each instantiated canonical query tree into a corresponding natural language question using a plurality of question templates associated with a corresponding query flow path.
